(19) United States
(12) Patent Application Publication
(10) Pub. No.: US 2001/0054134 A1
(43) Pub. Date: Dec. 20, 2001

(54) Data management systems

(75) Inventors: Shoichi Nagatomo, Tokyo (JP); Yoshiyuki Murata, Tokyo (JP); Akihiro Tsukamoto, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 09/881,938

(22) Filed: Jun. 14, 2001

(30) Foreign Application Priority Data
Jun. 15, 2000 (JP) 2000-180289
Jun. 30, 2000 (JP) 2000-198789

(51) Int. Cl. G06F 13/28

(52) U.S. Cl. 711/163; 707/104.1; 705/27

(57) ABSTRACT

A data managing apparatus that manages various data such as contents in a simple storage/read controlling process, using a distributable recording medium. A card 10 has a first or static storage area IC7 adapted to be accessed in a first access method and having stored compressed high-quality music data and compressed high-quality image data, and a second or dynamic storage area CD2 adapted to be accessed in a second access method and having stored non-compressed high-quality music data and non-compressed high-quality image data. A portable player 10 or a household CD card reader 110′ as a reproducer can retrieve and replay the high-quality music data and image data by referring to the compressed music data and image data stored in the IC7.

### BACKGROUND OF THE INVENTION

1. Field of the Invention

The present invention relates to data management apparatus, data management methods, data readers, information management systems and data reading methods.

2. Prior Art

There have been proposed techniques that provide a plurality of storage sections in a single storage medium and store various kinds of data in the respective storage sections, for example, as disclosed in Unexamined Published Japanese Patent Applications Hei 10-142446, 10-171697, and 11-161750.

The Application Hei 10-142446 a technique that uses a hybrid optical recording medium, which includes a first optical area for recording information in advance according to a standard format of high-level configuration, and a second optical area where additional information is written, called back, deleted or changed by a computer connected to the disk drive unit. Thus, original information can be previously stored in the first optical area in a mass production process and additional information to be written on the disk can be added to the second optical area.

The Application Hei 10-171697 discloses a hybrid card having an optical recording area for recording data and management information, and an IC chip capable of rewriting information. An information recording/reproducing device is used to record data and its management information on the optical recording area of the card and also record on the IC chip address information of predetermined items of all management information recorded in the optical recording area. Therefore, before accessing the optical recording area, address information is read from the IC chip, and management information at the related address is reproduced from the optical recording area.

The Application Applications Hei discloses a storage medium in the form of a DC-ROM, which includes an antenna coil and an integrated circuit connected to the antenna coil. The storage medium proper has game software already stored, whereas the integrated circuit has a built-in nonvolatile memory. The progress of the game played based on the game software is stored in the integrated circuit.

With recent diffusion of PCs (Personal Computers) and the Internet, the user frequently stores in PC various kinds of information to be maintained or very often downloads contents from various servers and stores them in PC. Generally, information to be stored and downloaded contents are stored and managed in the hard disks in the PCs. However, as information and contents to be stored become diversified, the percentage of the hard disk occupied by them increases immensely, thus hampering the other work that will be carried out on the PC.

Possible solutions of this problem are to utilize the above-mentioned Applications to store various kinds of information which should be retained, and the downloaded contents in external storage media to thereby manage them. With the Application Hei 10-142446, the first optical area has stored original information beforehand in a mass production process, and furthermore the second optical area stores additional information, which is to be written to the disk. Because the original information is stored in the optical area in advance in the mass production process, this technique is inappropriate for storing information to be stored personally and any downloaded data.

In the Application Hei 10-171697, data and its management information are recorded in the optical recording area on the card, and address information of specified items of all management information recorded in the optical recording area is recorded on the IC chip. Therefore, three kinds of information must be stored in the card, which information are \mathring{1} data, \mathring{2} data management information, and \mathring{3} address information for the management information, which makes the storage control process complicated. As the amount of data to be stored increases, the amount of data management information and address information thereof increases, thus prolonging the storage time.

Further, in the Application Applications Hei 11-161750, game software is stored in advance in the recording medium and the changing situation in the course of the game to be played according to the software is recorded and stored in the integrated circuit element. Therefore, it is impossible for the PC user to store and manage the various items of information and the downloaded contents that he or she wishes to retain.

### SUMMARY OF THE INVENTION

The present invention has been made in view of the above problems. It is an object of the present invention to provide a data management apparatus, a data management method, a data reader, an information management system and a data reading method, which can manage information that the user needs to retain and various items of data such as downloaded contents, in a simple storage control process.

In order to achieve the above object, the present invention provides a data managing apparatus for accessing a recording medium that comprises a first storage area in which information is stored in a first access method and a second storage area in which fixed data is stored in a second access method different from the first access method, the apparatus comprising:

connecting means for connecting the recording medium via a network to a server system on the Internet;

storage control means for storing changing data, related to the fixed data and read from the server system, in the first storage area in the first access method; and

reading means for reading the fixed data corresponding to the changing data in the second access method from the second storage area.

As described above, according to the invention, the recording medium is only required to store changing data to thereby simplify the storage control. Since the changing data is related to fixed data, the fixed data can be read out based on the changing data. Thus, the fixed data is placed in a manageable state.

### BRIEF DESCRIPTION OF THE DRAWINGS

FIGS. 1A and 1B show one embodiment of a card-type storage medium according to the present invention;

FIGS. 2A and 2B show compositions of two storage areas different in access method to the card shown in FIG. 1;

FIGS. 3A and 3B show compositions of two storage areas (an IC and a CD) different in access method to the card;

FIGS. 4A and 4B show one embodiment of a card reader that accesses the storage areas different in access method to the card and reads stored data;

FIGS. 5A and 5B show examples of data (files) stored in the storage areas, different in access method, provided on the card;

FIG. 6 shows one embodiment of a parts inventory control device using a card having the storage areas different in access method;

FIG. 7 is a flowchart of operation of the parts inventory control device using a card having the storage areas different in access method;

FIGS. 8A and 8B show examples of data (files) to be stored in the storage areas, different in access method, provided on the card;

FIGS. 9A, 9B and 9C show another examples of data (files) to be stored in the storage areas, different in access method, provided on the card;

FIG. 10 is a flowchart of operation of a navigation device using a card having the storage areas different in access method;

FIGS. 11A and 11B show examples of storage areas of a card different in access method provided in a contents browsing device made of a terminal such as a portable information terminal or a personal computer;

FIGS. 12A and 12B show another examples of storage areas of a card different in access method provided in a contents browsing device made of a terminal such as a portable information terminal or a personal computer;

FIGS. 13A and 13B each illustrate reproduction of compressed data and high-quality data stored in a card having storage areas different in access method;

FIGS. 14A and 14B each show a composition of security data stored in the IC;

FIG. 15 illustrates an information management system according to the present invention;

FIG. 16 illustrates another information management system according to the present invention;

FIGS. 17A and 17B show a composition of an optical storage area of a contents card having stored contents;

FIGS. 18A, 18B, 18C; 18A′, 18B′, 18C′ each show a composition (area layout) of an optical storage area of the contents card in FIG. 17;

FIGS. 19A and 19B show one embodiment of free contents (file) stored in a free contents area;

FIGS. 20A and 20B show one embodiment of pay contents (file) stored in a pay contents area;

FIGS. 21A and 21B show another embodiment of a contents card having stored contents;

FIGS. 22A and 22B show yet another embodiment of a contents card having stored contents;

FIGS. 23A, 23A′ and 23B, 23B′ show compositions (area layouts) of storage areas of contents cards 211, 211′ shown in FIGS. 21 and 22, respectively;

FIGS. 24A, 24B and 24C show one embodiment of a contents card device to be connected to (or incorporated in) a contents browsing terminal;

FIGS. 25A, 25B and 25C each show one embodiment of a contents card browsing terminal;

FIG. 26 illustrates one embodiment of a network system used in a selling method of contents according to the present invention;

FIGS. 27A and 27B each illustrate a process chart of a selling method of contents in the network system in FIG. 25;

FIG. 28 shows a composition of a server;

FIGS. 29A-29E each show a composition of data to be stored in a respective one of files stored in a data base;

FIG. 30 shows a composition of a stationary terminal;

FIGS. 31A-31E each show one embodiment of a screen image displayed on a stationary terminal monitor;

FIG. 32 is a flowchart of operation of the stationary terminal, e.g., in renewing the valid number of times of card use;

FIG. 33A and 33B show a flowchart of operation of the server; and

FIG. 34A and 34B show a flowchart of a program capturing (receiving) operation at the contents browsing terminal.

### DESCRIPTION OF PREFERRED EMBODIMENTS

Embodiments of the present invention will be described in detail in the following.

A. First Embodiment

A Storage Medium having Storage Areas Different in Access Method

1. Storage Medium

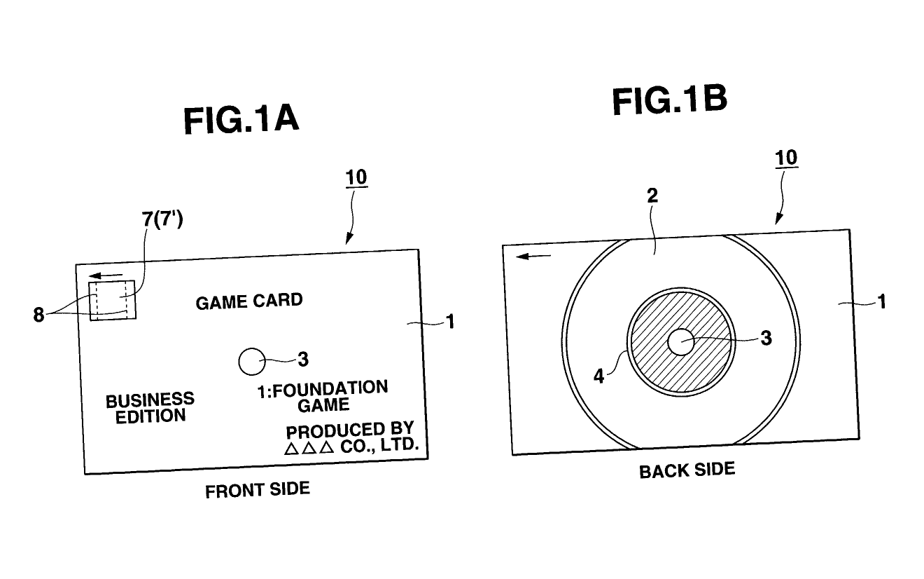

FIG. 1 shows a card-type storage medium in one embodiment of the present invention (hereafter referred to as a card 10). Card 10 has an electronic storage area mounted on the front side (or the back side) thereof (in this example, an IC 17 attached to, or embedded in, a substrate 1), and an optical storage area provided on the back side (or the front side) (in this example, a non-circular CD 2 attached to, or embedded in, the substrate 1). In FIG. 1, reference numeral 3 denotes a hole provided at the center of the card substrate 1; 7 an electronic storage area; and 8 terminals used to electronically read or write information therethrough. While the card 10 is illustrated as having an optical storage area 2 that includes non-circular optical storage tracks, the optical storage area 2 may consist only of circular optical storage tracks.

The card 10 takes the form of a visiting card having the IC 7 embedded on the front (back) side as shown in FIG. 1A. Also, information is printed on the front (back) side to show the usage of the card 10 and the data stored (as a character string and a picture; in the case of a game card, a title or illustration showing the contents of the game and a production firm's name, etc.). Moreover, for example, an arrow mark showing an inserting direction of the card 10 into the terminal (insertion guide), and character information about applicable models and a card using method may be printed.

While FIG. 1 shows the CD 10 that has the IC 7 and CD 2 provided on one and the other side thereof, respectively, the IC 7 and DC 2 may be provided on the same side. A plurality of ICs 7 may be installed on the card 10.

2. Composition of Memory

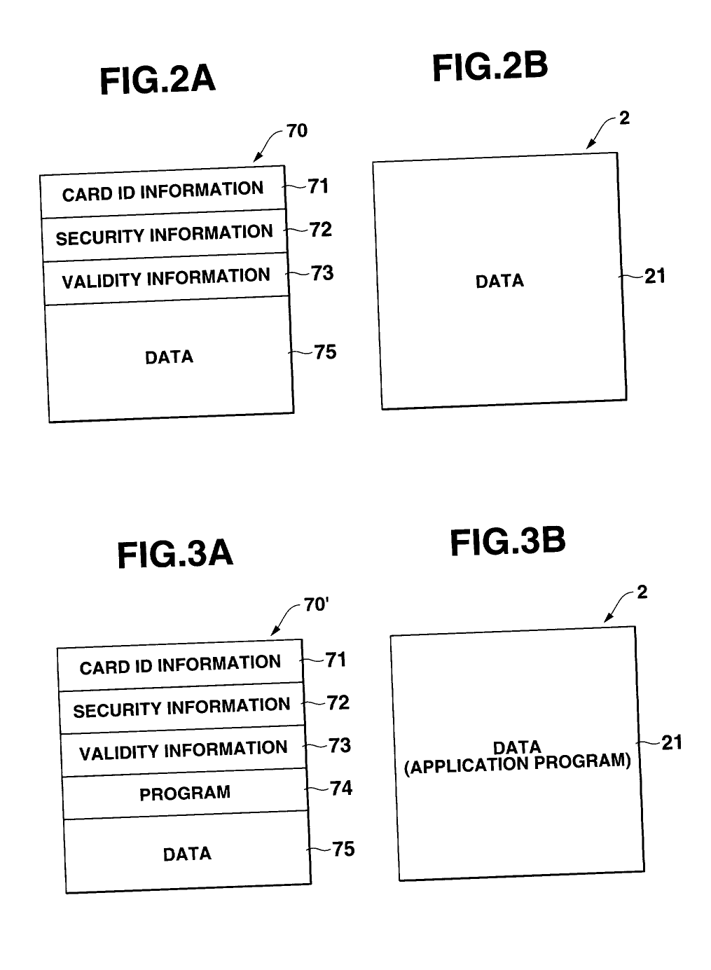

FIGS. 2 and 3 illustrate compositions of the two storage areas (IC 7 and CD 2), which are accessed in different methods, on the card 10 in FIG. 1.

FIG. 2A shows the electronic storage area or a storage area layout of the IC 7 of the CD card 10. The IC 7 (=a memory 70) includes a card identification information area 71, a security information area 72, a validity information area 73 and a data area 75. The card identification information area 71 contains identification information of the card 10 such as the kind and card number of the card 10. The security information area 72 contains data for card security, and the validity information area 73 contains card validity information such as the valid usable number of times of the card (or the valid usable count of the card). The data area 75 contains a small capacity of character data, parameters or transaction data (changing data).

FIG. 2B shows a data area 21 having a large data capacity provided on the optical storage area CD 2 of the CD card 10.

FIG. 3A shows the card identification information area 71, security area 72, validity information area 73, program area 74 and data area 75 provided in a memory 70′ in an IC 7′, which also incorporates a microprocessor. The card identification information area 71 contains identification information of the card 10, such as the kind and card number of the card 10. The security area 72 contains data for card security. The validity information area 73 contains card validity information such as the valid number of times of card use (or the valid usable count of the card). The program area 74 stores programs, character data and setting values. The data area 75 stores data of a small capacity such as parameters and changing data.

FIG. 3B shows data area 21 having a large data capacity provided in the optical storage area CD 2 of the CD card 10 (in this case, the data to be stored is a game application program).

3. Different Methods for Accessing the Storage Areas on the Card Different in Accessing Method

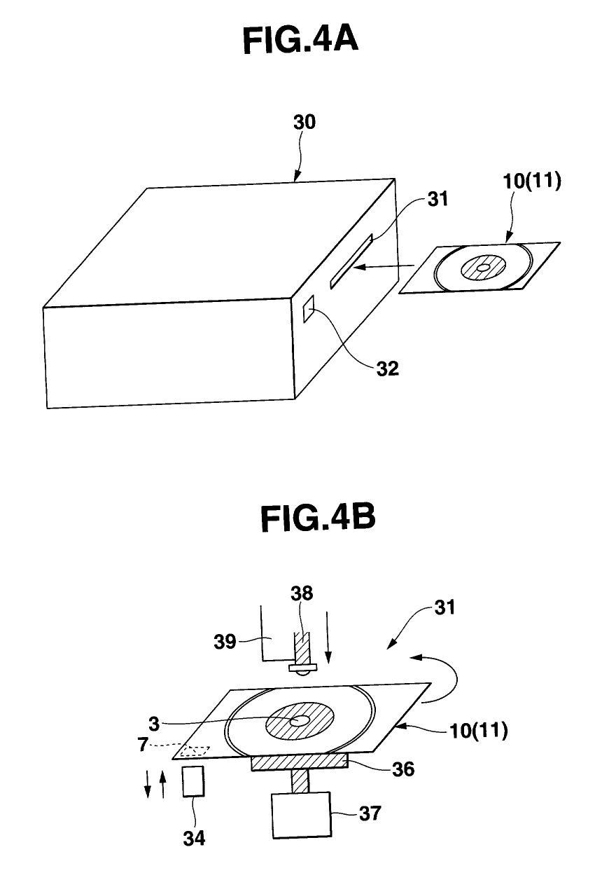

FIGS. 4A and B show one embodiment of a card reader for reading in different accessing methods data stored in the storage areas IC 7 (7′) and CD 2) on the card 10. FIG. 4A illustrates the appearance of the card reader, and FIG. 4B illustrates an access unit 31 (the card drive mechanism and the read/write mechanism) provided on the card reader.

As shown in FIG. 4A, the card reader 30 has on its front a tray insert/eject slot 31 for a movable tray (not shown) on which a card 10 is guided into/out of the card reader 30, and a tray drive button 32.

As shown in FIG. 4B, the card access unit 31 includes an IC read/write sub-unit 34, a fixing table 36 for fixing card 10 thereon, a motor mechanism 37 for rotating the card 10 together with the fixing table 36, a shaft 38 for securing the card 10 to the fixing table 36, and an optical read/write sub-unit 39 moved by an arm (not shown). When a card 10 is set and stationary, the IC read/write sub-unit 34 is in electrical contact with the IC 7 provided on the front side (or, on the same side as the optical storage area) of the card 10 for transmitting or receiving information to, or from, the IC 7.

As shown in FIG. 4B, when the card 10 (11) inserted into the card reader 30 is placed on the fixing table 36, the shaft 38 moves downward to fix the card 10 (11) to the fixing table 36. This causes the motor mechanism 37 to rotate the fixing table 36 along with CD card 10. The optical read/write sub-unit 39 moves with the moving arm driven based on a control signal from a CPU built in the terminal or the card reader, reads information from the optical storage area 2 on the CD card 10 and outputs a corresponding electrical signal. If the optical storage area 2 (or a part of its area) is configured as rewritable, the electrical signal (information) can be converted into an optical signal, which is then writable into the optical storage area 2.

When the card 10 is not rotating (in other words, when the card starts to rotate, or when its rotation is stopped or terminated), the IC read/write sub-unit 34 moves at specified timing to bring its terminals into electrical contact with the terminals of the IC 7 embedded in the underside of the card 10, and reads stored information from the IC 7, or writes data into the IC 7.

In other words, by using the card reader 30 of FIG. 4 as the card read/write device for a terminal such as a personal computer, a special-purpose portable information terminal or a stand-alone type terminal, it is possible to read data stored in the optical storage area 2 and the IC 7 of the card 10, to reproduce it for use in a specified application, and to write resulting data back to the card 10.

FIG. 4B shows the internal mechanism of the terminal that reads information stored in the optical storage area 2 and the IC 7 provided on the opposite sides of the card 10. In contrast, the terminal may be configured so as to have the IC reader 34 mounted on the same side as the optical reader 39 to thereby read information from the optical storage area 2 and the IC 7 both arranged on the same side of the card.

In FIGS. 4A and B, the single-type card device 30 is shown which reads data from the CD 2 of the card 10 and reads/writes data from/to the IC 7, but the present invention is not limited to this particular configuration. For example, the CD 2 of the CD card 11 may be rotated and read by a dedicated CD card reader whereas data stored in the IC 7 may be read by a dedicated IC read/write device.

4. Contents of Data to be Stored in Storage Areas Different in Access Method

Data to be stored in the card 10 is stored in the IC 7(7′) and the CD 2 of the card 10 in corresponding different access methods, that is, in an electronic quick-access method and a less-quick access method suitable for storing a large amount of data.

4-\mathring{1} Method of Storing Changing and Fxed Data in the IC and the CD, Respectively

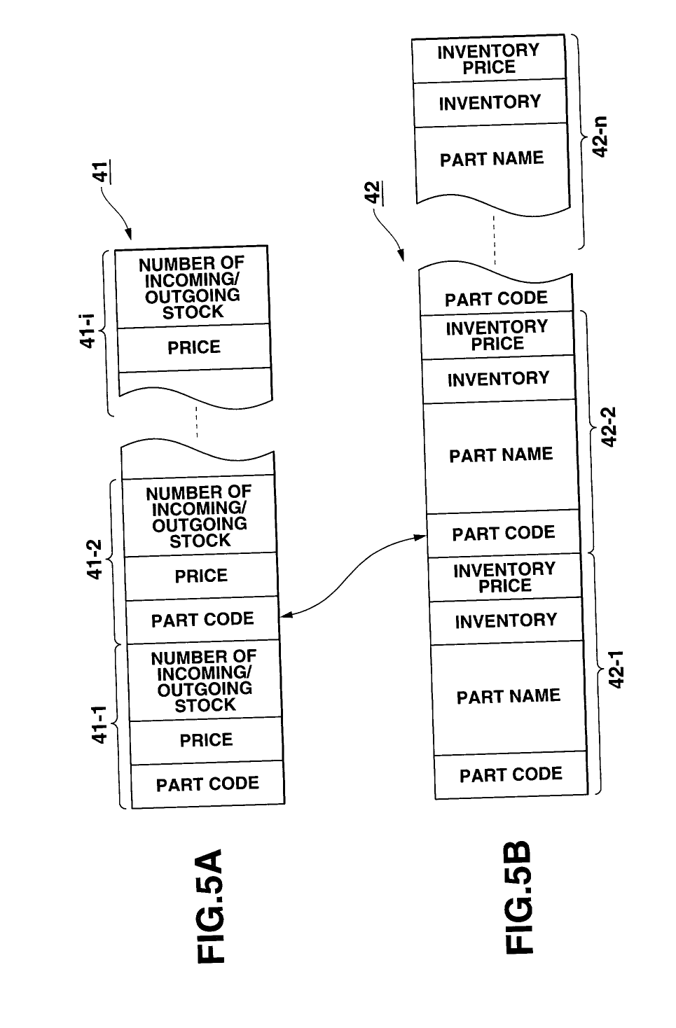

FIG. 5A shows a changing part data file 41 that has changing parts data sections 41-1 through 41-i set in the data area in the memory 70(70′) of the IC 7(7′) of a card 10 for inventory control of the parts. FIG. 5B shows a parts file 42 of parts code sections 42-1 through 42-n set in the data area 21 of the CD 2 of the card and having stored part codes as fixed data.

In FIG. 5A, each changing parts data section has a parts code field, and an incoming/outgoing stock count field in which corresponding data are stored each time incoming/outgoing stock appears (the number of incoming stock=+, the number of outgoing stock=−).

In FIG. 5B, each parts code section has (a parts code field, a part name field, an in-out stock count field and an amount of stock (a purchase amount of parts in stock) field in which corresponding data is stored.

In the illustrated example, data stored in the parts code field of the changing parts data section 41-2 is associated with data in the parts code section 42-2 of the parts code file 42 of CD 2.

### Operation

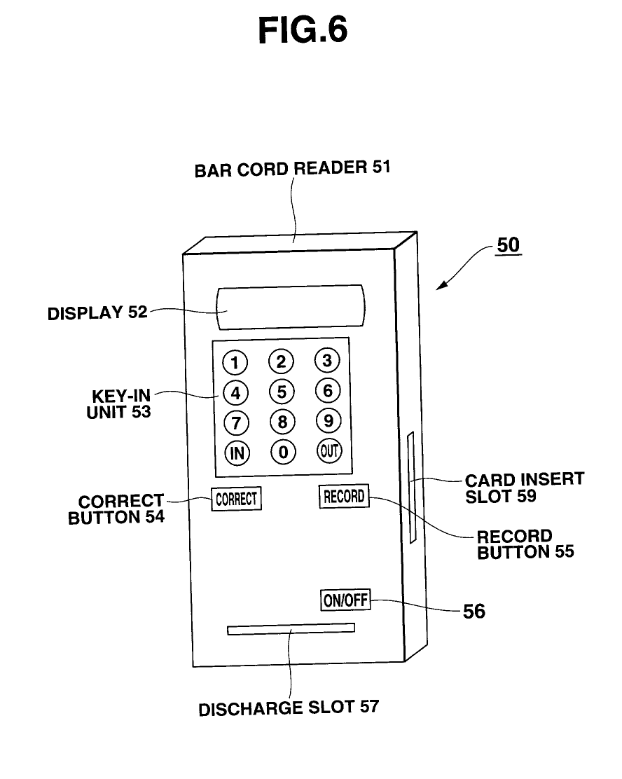

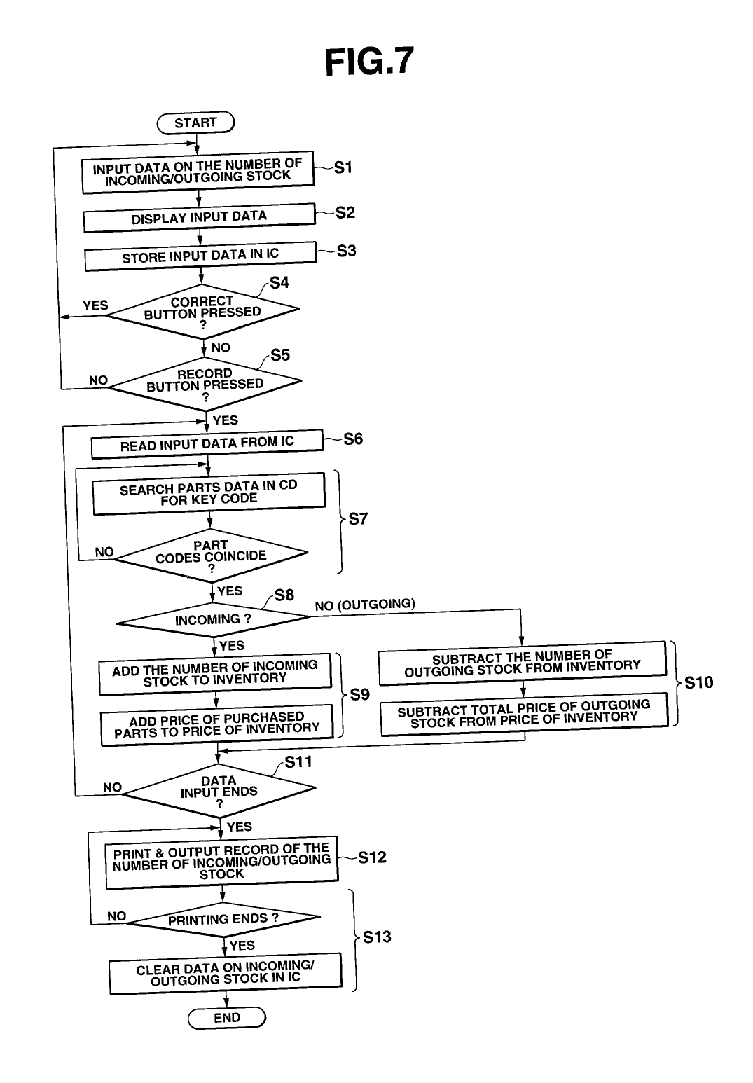

FIG. 6 shows one embodiment of a portable parts inventory control device or terminal using a card 10. FIG. 7 is a flowchart of operation of the inventory control device. In this example, the card 10 is inserted into a card insert slot 59 in the inventory control device 50, and then placed on a card access unit 31 (FIG. 4B) provided within the inventory control terminal 50.

As shown in FIG. 7, when parts are put/delivered in/from store, the person in charge enters changing data on a parts code, a purchase price, and an in-out stock count with the key-in unit 53 of the inventory control terminal 50 or with an optical character reader 51, such as a bar code reader, provided at the inventory control terminal (step S1).

The data input in the step S1 is displayed on the display 52 (step S2), and stored in the appropriate section of the changing parts data file 41 in the data area 75 of the IC 7(7′)(step S3). If the person in charge depresses the correct button 54, the data stored in that section of the changing parts data file 41 is cancelled, and the control returns to step S1 that enables data to be input again (step S4).

When the person in charge depresses the record button provided on the inventory control terminal 50 (step S5), the terminal accesses the IC 7(7′) to thereby sequentially read changing parts data from the changing parts file 41 (step S6).

Next, the terminal 50 accesses the CD 2 to search the parts file 42 stored in the data area 21 of the CD 2 for a key parts code of the changing parts data 41 read in step S6 (step S7). If a parts code is found which coincides with the key one, the terminal examines the parts data to see whether parts are put in or delivered from stock (signs “+” and “−” in the in-out stock count field indicate that the parts are respectively put in and delivered from stock) (step S8).

When the parts are put in stock, the number of incoming stock in the changing parts data section is added to the value of the inventory field for the parts code coincident with the key to renew the data in the inventory field, and data in the price-of-the-inventory field for the parts is renewed by adding the purchase price (=the number of incoming stock×unit purchase price) to the price of the inventory field for the parts (S9). When parts are delivered from stock, the number of parts in the inventory field in the corresponding changing parts data section is renewed by subtracting the number of outgoing stock from the inventory field for the parts code coincident with the key, and the inventory price field is renewed by subtracting the purchase price (=the number of outgoing stock×the average inventory price of the stock) from the value in the price inventory field for the parts(S10).

When renewing the CD 2 ends, the terminal 50 again accesses the IC 7(7′) and repeats steps S6 to S9 (S10) until renewal of the CD 2 with all input changing parts data (S11) is completed. When the renewal of the CD 2 is completed, the changing parts data stored in the parts file 42 of the CD 2 is edited and printed, and discharged as records of incoming and outgoing stock from a recording paper discharge slot 57 (S12). After printing of the changing parts data is completed, the data stored in the changing parts file 41 of the IC 7(7′) is cleared (S13).

Note that the terminal can access the DC 2 in step S2, search the parts codes stored in the parts file 42 for the parts code input in step S1 as a key, extract the parts name for the parts data that coincides with the key and display it on the display 52.

As is obvious from FIGS. 5 to 7, changing data such as the in-out stock data is recorded in the quick-accessible IC 7(7′) and a fixed portion of the parts data, that is, composing ledger data is recorded on the CD 2. The fixed data can be renewed with the changing data at desired times. In this case, since the CD of the card 10 has a capacity of 30 megabytes (30 MB) or so at present, the terminal can manage 300,000 records, that is, 300,000 kinds of parts, including standards, if parts data (fixed data) consists of records each 1 KB long, and therefore can sufficiently manage a large number of parts.

Further, since the changing data recorded in the IC 7(7′) can be written into the CD 2 when necessary (by manipulating the record button, for example), and even if there are a large number of changing data, the limited recording capacity of the IC 7(7′) does not make it necessary to frequently replace the card 10 by other cards.

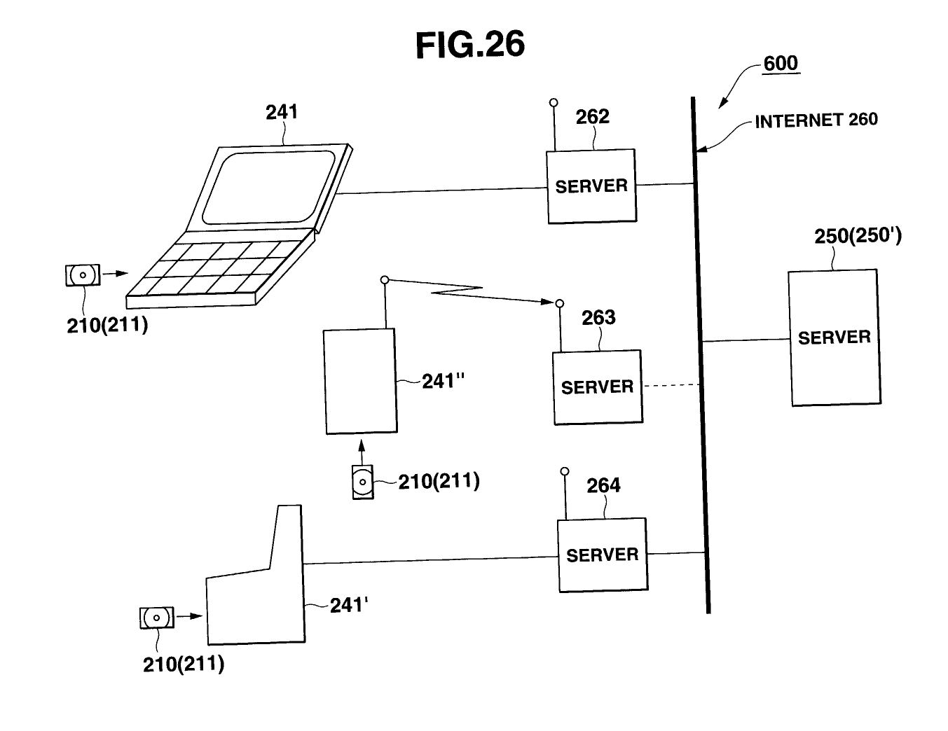

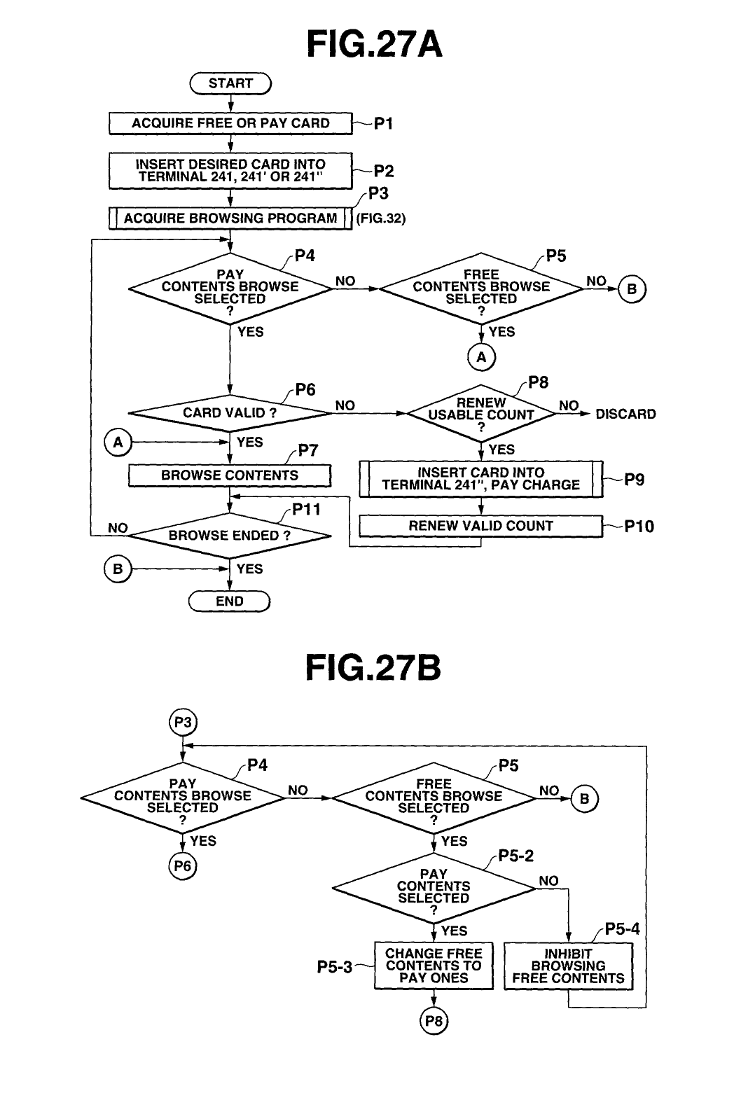

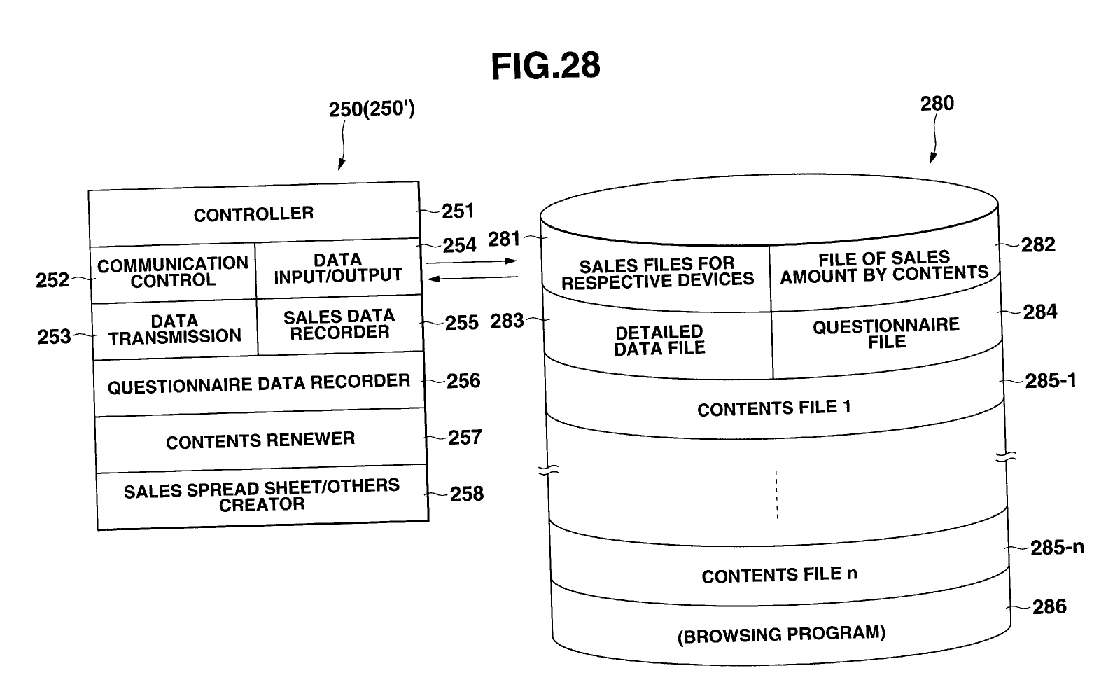

For the inventory control of the parts mentioned above, an information management system 600 using the Internet 260, as shown in FIG. 26, can be used. The management system 600 includes a server 250(250′) (see FIG. 28) connected to the Internet 260, a plurality of user terminals (PCs) 241 connected to the Internet 260 via a server 262, a plurality of mobile wireless terminals 241″ connected wirelessly to a sever 263 that may be connected to the Internet 260, and a stationary type terminal 241′ connected to the Internet via a server 264. The stationary type terminal 241′ is equipped with not only a function to connect to the Internet, but also with all functions of the inventory control terminal 50 shown in FIG. 6.

When parts are put in, or delivered from, stock, the stationary type terminals 241′ reads changing data such as a parts code, a purchase price, the number of incoming/outgoing stock, etc., from the server 250, and stores changing parts data, thus obtained, in the changing parts file 41 in the data area 75 of the IC 7(7′). When the person in charge manipulates the terminal 241′ corresponding to the record button 55 on the inventory control terminal 50, the terminal 241′ accesses the IC 7(7′), and sequentially reads changing parts data from the changing parts file 41.

Then, the terminal 241′ searches the parts file 42 stored in the data area 21 of the CD 2 for a key part code of the read changing parts data file 41. When the part code is found which coincides with the key, the terminal 241′ checks to see whether the parts are put in, or delivered from, stock (the signs “+” and “−” indicate incoming and outgoing stock, respectively).

When the parts are put in stock, the value of the inventory field for the parts is renewed by adding the number of incoming stock in the corresponding changing parts data section to the inventory field for the part code coincident with the key. The value of the inventory price field is renewed by adding the purchase price (=the number of incoming stock×unit purchase price) to the value in the inventory price field. When parts are delivered from stock, the value in the inventory field is renewed by subtracting the number of outgoing stock in the changing parts data file from the value of the inventory field for the part code coincident with the key. Also, the value in the inventory price field is renewed by subtracting the purchase price (=the number of outgoing stock×the average unit inventory price of the parts) from the total price value in the inventory price field.

When the renewal of the CD 2 by the changing parts data is completed, the changing parts data stored in the parts file 42 of the CD 2 is edited, printed, and then ejected as a record of the in-out stock from the recording paper discharge slot 57. After printing of the changing parts data, the data stored in the changing parts file 41 of the IC 7(7′) is cleared.

The above-mentioned storage method is not limited to parts control, but may be utilized in various types of applications in which changing data is input and a ledger file (fixed data) is renewed.

The applications include an accounting process system in which accounting data (journal data) as changing data is recorded on a card 10 set in the accounting terminal, and the accounting master file is recorded on the CD 2; and a sales (or customer) management system in which merchandize sales data is recorded as changing data in the IC 7(7′) of a card 10 set in the recording terminal, and a commodity classified sales master file and a customer-classified sales master file are recorded the CD 2. Yet another possible application is an athletic record system wherein records classified by athletes and events at sports meets are recorded as changing data on a card 10 inserted into the athletic record terminal, and an athlete-classified record master file, for example, is recorded on the CD 2.

4-\mathring{2} Method of Recording Local Data (or Non-Standard Data) in the IC, and Wide-Area Data (or Standard Data) on the CD

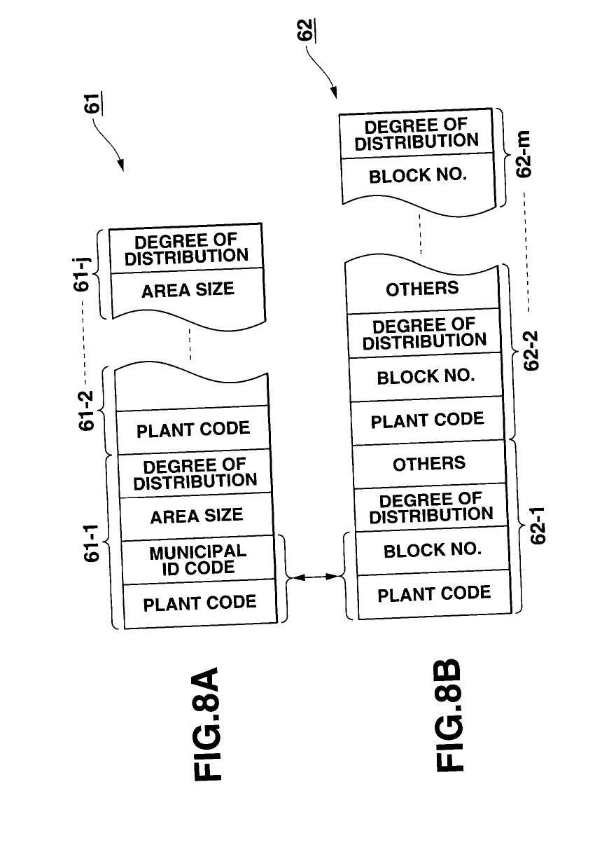

FIG. 8A shows one embodiment of an area vegetation distribution file 61 set in the data area 75 in memory 70 of the IC 7(7′) of a card 10 used for A vegetation survey. An area vegetation distribution file 61 contains area-specific vegetation distribution data 61-1 through 61-j each containing an ID code (plant code) of plants distributed in an area under survey, an ID code of a municipality area under survey (a block No.+a municipality code), an area size, and a degree of distribution. FIG. 8B shows a nationwide vegetation distribution file 62 set in the data area 21 of the CD 2. This distribution file 62 contains wide-area vegetation data 62-1 through 62-m. The wide-area vegetation data 62-1 through 62-m each contain a plant code, a block (a prefectural block and an island block, for example Yaeyama Island block) No., a degree of distribution, and others.

In the illustrated example, a plant code and a block code (of a municipality code) of vegetation distribution data 61-n stored in the area vegetation distribution file 61 of the IC 7(7′) is associated a plant code and a block No. of corresponding vegetation data of the file 62 in the CD 2.

### Operation

In this example, the card 10 is inserted in a portable type survey terminal (not shown) and read by the card access unit (see FIG. 4B) of the survey terminal. The survey terminal comprises a display, a key-in unit, and a controller.

In the survey of vegetation, when an investigator keys in data on a result of survey of plants in an area under survey, such as a plant ID code, a municipality ID No., a size of the area, and the distribution of the plants, plant distribution data is produced based on the data inputted, and recorded in an area-specific vegetation distribution file 61 in the IC 7(7′).

In the survey, the investigator not only inputs the data, but also manipulates the wide-area function button on the survey terminal to access the CD 2 to thereby search wide-area vegetation data recorded in the nationwide vegetation distribution file 62 of the CD 2 for the plant code and the block number included in the municipality code as keys. If no great difference is found in comparison of the vegetation of the plants at the site of survey with the wide-area vegetation data recorded in the file 62, the plants at the site of survey may be removed from the list of plants under survey or may be recorded separately as being identical to the wide-area vegetation.

After the survey, the investigator manipulates the wide-area function button provided on the survey terminal to access the CD 2 and searches the wide-area vegetation data recorded in the nationwide vegetation distribution data file 62 on the CD 2 for the target plant code and the block number included in the municipality ID code as the keys and compare the vegetation distribution corresponding to the keys with the survey results stored in the area vegetation distribution file 61 in the IC 7(7′). If there is no statistical difference between them, the survey results are regarded as being not vegetation indigenous to the area and removed from the survey list, or may be treated as being identical to the wide-area vegetation and recorded separately.

As is clear from the example in FIG. 8, the IC 7(7′) has a limited storage data capacity, but quickly accessible. Thus, local data such as area-based data can be stored in the IC 7(7′) for ready reference, whereas wide-area data of a large size can be stored on the CD 2 so as to be compared with the local data when necessary.

Data considered as being of a non-standard type, for example, data on commodities (such as local products) other than those bought in by joint purchase for chain stores may be stored in the IC 7(7′), whereas standard data (on joint-purchased commodities for chain stores) may be stored on the CD 2.

4-\mathring{3} Method of Storing Search Data (Search File) in the IC and Data, to be Searched, on the CD

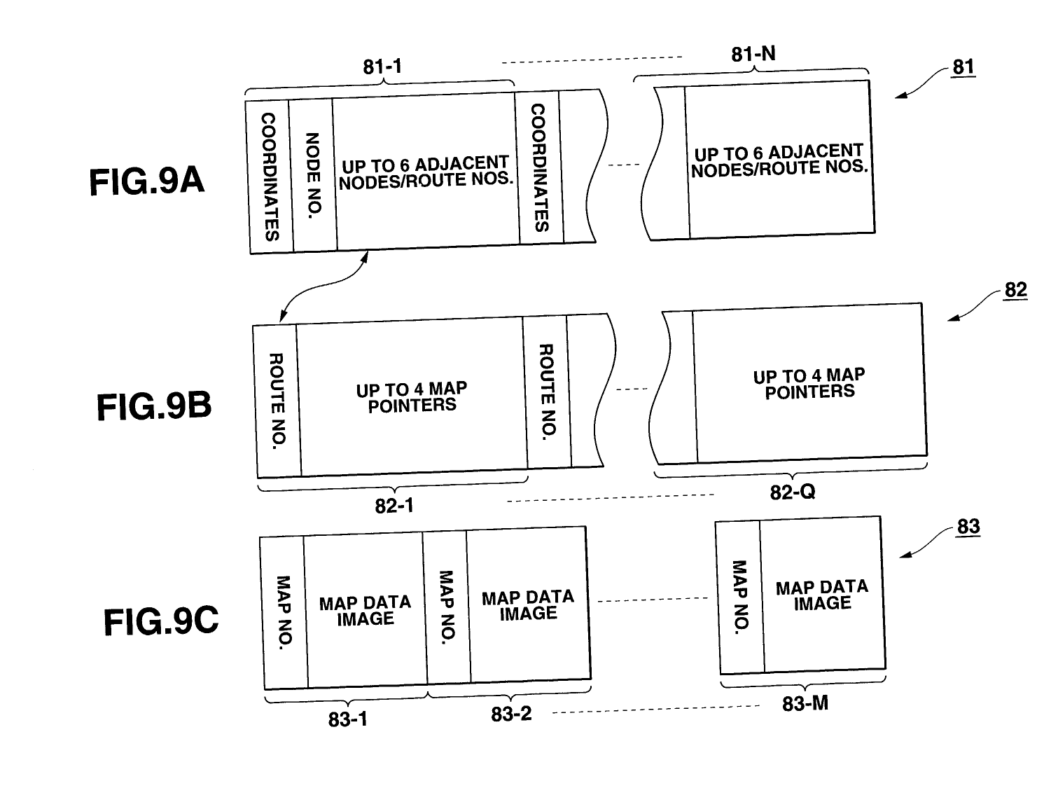

FIG. 9A shows one embodiment of a route data file 81 retained in a data area 75 of the memory 70(70′) of the IC 7(7′) of a card 10 used in a navigation system. The route data file 81 contains route data sections 81-1 through 81-N. FIG. 9B shows a composition of each of map search data sections 82-1 through 82-Q stored in a map search file 82 set in a data area 21 on the CD 2 of the card 10. FIG. 9C shows map file sections 83-1 through 83-M including image information in a map file 83 set in the data area 21 of the card 10.

In FIG. 9A, each of route data sections stored in route file 81 includes a coordinate field, a node number field, and an adjacent node number (route number) field that have respectively stored coordinate values, a node number of a node closest to the coordinate values, the next node numbers selectable from the closest node, and a route number(s) of a route(s) represented by a segment(s) that connect the nodes.

In FIG. 9B, the map search file sections 82-1, . . . , 82-Q stored in the map search file 82 each include a route number field and a map pointer field that have respectively stored a route number and a pointer(s) pointing to map information, including data on the above-mentioned route(s) (in other words, a segment extending from one node to the next node).

In FIG. 9C, a map file 83 contains map file data sections 83-1, 83-2, . . . , 83-M, each comprising a map number and map (image) data.

In this illustrated example, the route data sections 81-1 through 81-N stored in the route data file 81 in the IC 7(7′) are associated with the map file data sections 83-1 through 83-M by the corresponding route numbers of the route data sections 81-1 through 81-N and the map search file sections 82-1, . . . 82-Q.

### Operation

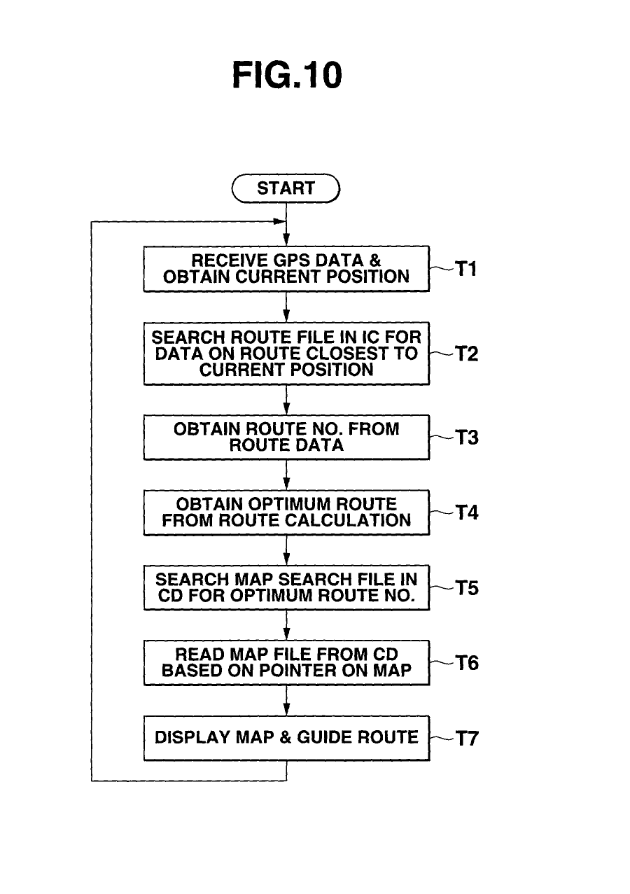

FIG. 10 is a flowchart of operation of the portable navigation system (not shown) using a card 10.

The portable-type navigation system has a GPS receiver and a display unit, by which the navigation system obtains the current position from GPS data received by the GPS receiver and displays a route to a destination to thereby guide the user. The card 10 is set in a card receiver of the device and is read by a card access unit provided in the navigation system.

When the navigation system is started up and a destination is input, the GPS receiver unit intermittently receives GPS data and obtains coordinates of the current position (step T1).

Then, the navigation system accesses the IC 7(7′), and searches the coordinate value fields of the route data file 81 for data on a route related to coordinates closest to the current position (step T2).

Further, the navigation system reads a node number, an adjacent node number and a route number from the node number field and the adjacent link pointer field of the route data section obtained in the step T2 (step T3). The system finds an optimum guide route by using a well-known route calculating method, and decides a route to the destination from the node closest to the current position to thereby obtain the next node and the optimum route (route number)(step T4).

Subsequently, the navigation system accesses the CD 2, and searches the map search file 82 for the route number obtained in the step T4 (step T5). Further, the navigation system reads a map pointer from the appropriate map pointer field, reads a map file corresponding to the map pointer from among the map file sections 83-1 through 83-M (step T6), and displays the map concerned, the current position, the next guide route and the destination on the display (step T7).

As described above, frequently-accessed data, such as data constants (numerical values, parameters (variables)) or search keys (an index file) may be stored in the IC 7(7′), thereby facilitating a search for map (image) data stored on the CD 2.

4-\mathring{4} Method of Storing Index Information (Text Data) in the IC and Image Data and Detailed Data on the CD

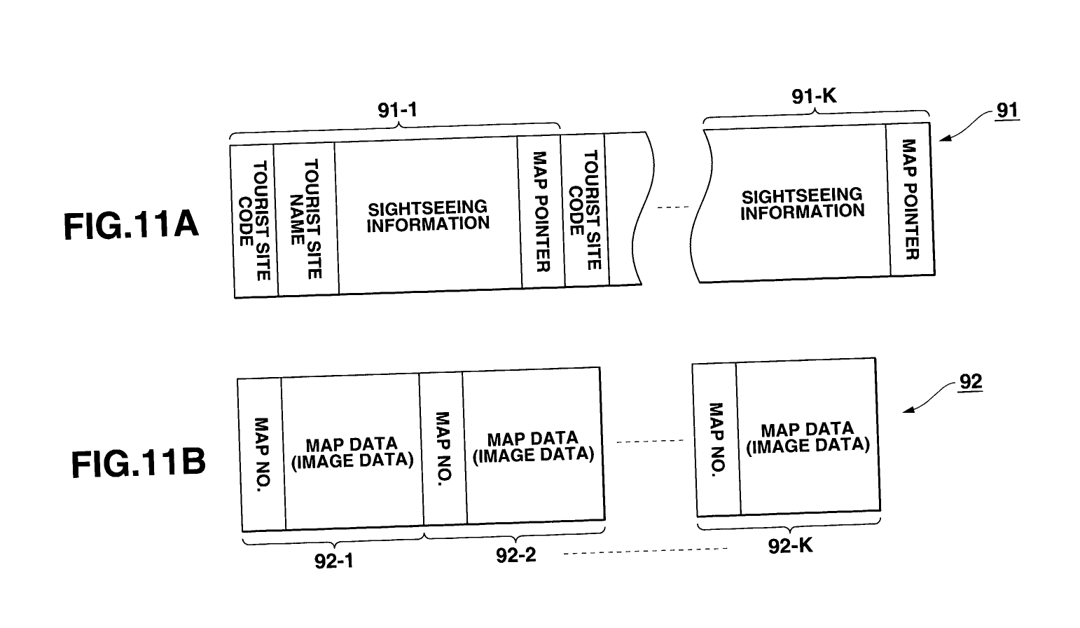

FIG. 11A shows an example of sightseeing site data sections 91-1 through 91-K stored in a guide data file 91 set in a data area 75 of the memory 70(70′) of IC 7(7′) of card 10. FIG. 11B shows an example of map file sections 92-1 through 92-K set in a data area 21 of the CD 2 of the card.

In FIG. 11A, the sightseeing site data sections 91-1 through 91-K stored in the guide data file 91 each have a sightseeing site code field, a sightseeing site name field, a sightseeing information field and a map pointer field for storing a sightseeing site code, a sightseeing site name, information regarding the sightseeing site, and a map pointer pointing to a storage address of a map file section stored on the CD 2, respectively. In FIG. 11B, the map file 92 includes map (image) data sections 92-1 through 92-K, each in turn including a map number and map (image) data.

In the illustrated example, the sightseeing site guide data sections 91-1 through 91-K stored in the sightseeing guide data file 91 in the IC 7(7′) are associated with map file sections 92-1 through 92-K stored on the CD 2 by map pointers in the respective map pointer fields thereof.

### Operation

In this example, the card 10 is set in a portable information terminal (not shown) that includes a display, a key-in unit, and a card receiver, or set in a card reader of a browsing terminal such as a personal computer. The card is read by the card access unit (FIG. 4B) installed inside the browsing terminal.

When the browsing terminal is started up, the IC 7(7′) is accessed, and guide data is read from the guide data file 91, and sightseeing site names and sightseeing guide information about and sightseeing sites are displayed in a table form on the display. When the user points to (or clicks on) a sightseeing site name with keys (or a mouse), sightseeing data that includes a site name pointed to (or clicked) is selected.

Then, by accessing the CD 2, a map file section stored on the CD 2 is read and a corresponding map is displayed on the screen, based on a map pointer stored in the pointed (or clicked) sightseeing guide data.

As described above, text data (character information) is stored in the IC 7(7′) and map data (image information) is stored on the CD 2. Thus, text data can be retrieved from the IC 7(7′) and displayed in a table form. By selecting desired information from the information table, one can read the desired image information.

Examples of the text data to be stored in the IC 7(7′) include the names of, and summarized information about, accommodations, sports facilities, amusement centers, etc., or the titles and introductions of books, paintings, music, machinery and commodities. The CD 2 may contain image data corresponding to the text data (photos of accommodations, sports facilities, and recreation facilities, the contents of books), music data, plans or photos of machines, and photos of commodities). It should be noted that in this example, detailed information stored on the CD 2 is not limited to image data and music data, but may include text data.

4-\mathring{5} Method of Storing Thumbnail Data in the IC and High-Definition Image Data corresponding to Thumbnail Data on the CD

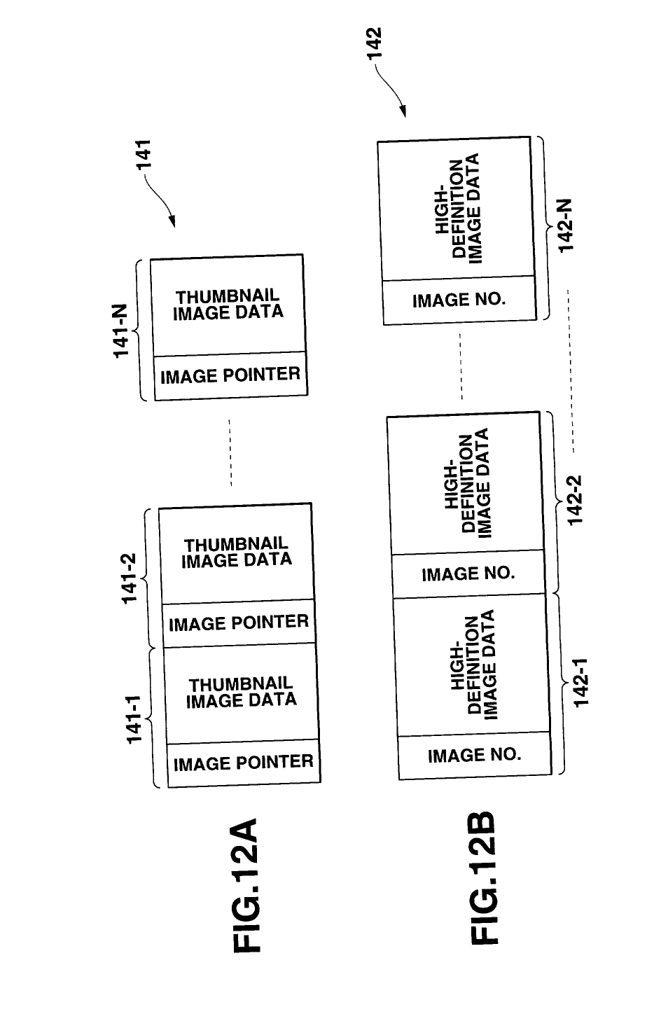

FIG. 12A shows a composition of each of thumbnail data sections 141-1 through 141-N stored in a thumbnail file 141 set in the data area 75 of the memory 70(70′) in the IC 7(7′) of card 10. FIG. 12B shows a structural example of image files 142-1 through 142-N stored in the data area 21 of the CD 2 of the card 10.

In FIG. 12A, the thumbnail data sections 141-1 through 141-N stored in the thumbnail data file 141 each contain a thumbnail data field that has stored thumbnail image data and an image pointer field that has stored an image pointer pointing to a storage address of high-definition image data on the CD 2. The thumbnail image data includes a reduced amount of high-definition image data stored on the CD 2. In FIG. 12B, the image file 142 comprises image data sections 142-1 through 142-N, each in turn comprising an image number and high-definition image data.

In this illustrated example, the image pointers of the thumbnail data sections 141-1 through 141-N stored in the thumbnail data file 141 in the IC 7(7′) are associated with the corresponding mage numbers of the image data sections 142-1 through 142-N of the image file 142 stored on the CD2.

### Operation

In this example, the card 10 is set in a portable information terminal (not shown), which comprises a display, an input keypad, and a card receiver, or in a card reader of a browsing terminal such as a personal computer, and is read at the card access unit (FIG. 4B) installed in the terminal.

When the browsing terminal is started up, the IC 7(7′) is accessed, thumbnail data in the thumbnail data file 91 is read, and the thumbnail images are displayed in a table form on the display. When the user points to (clicks on) any one thumbnail image with keys (or a mouse), the image data is selected.

Then, the CD 2 is accessed and one of the image file sections 142-1 . . . 142-N stored therein is read, based on an image pointer stored in the pointed-to or clicked specified thumbnail data, and the image is then displayed on the display.

Briefly, thumbnail data having a reduced amount of information is stored in the IC 7(7′) and high-definition image data, which corresponds to the thumbnail data, is stored on the CD 2. Thumbnail data can be displayed in a table form on the display. By selecting desired information from the table of information, a corresponding high-definition image can be viewed.

4-\mathring{6} Method of Soring Compressed Information in the IC and Uncompressed High-Definition Data on the CD, and a Method for Using Stored Information

Compressed data is stored in the data area 75 in the memory 70(70′) of the IC 7(7′) and high-definition data (uncompressed data) is stored in the data area 21 of the CD 2. The compressed data stored in the IC 7(7′) can be reproduced by a portable terminal. The high-definition image data stored on the CD 2 can be reproduced by a personal computer.

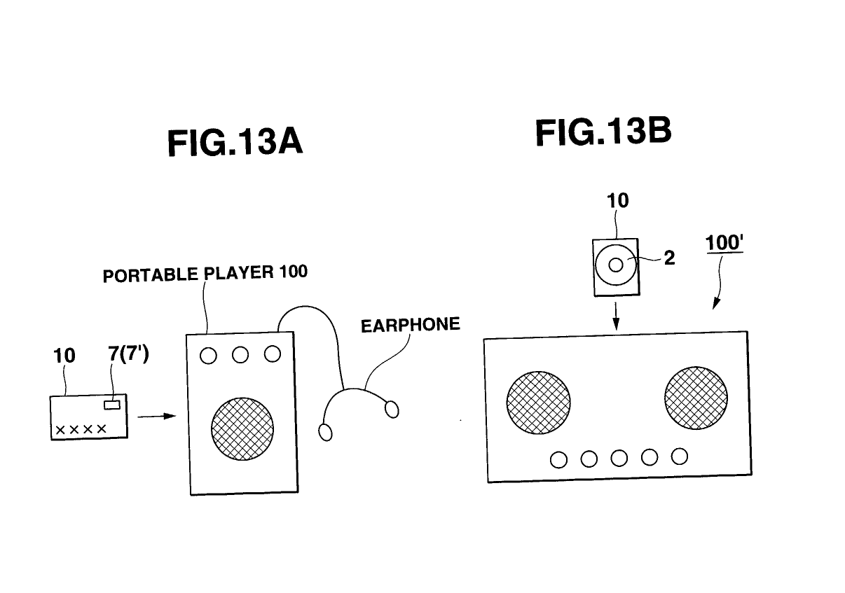

FIG. 13A shows that compressed image data stored in the IC 7(7′) of card 10 is being reproduced by the portable terminal. FIG. 13B shows that a high-definition image stored on the CD 2 of the card 10 is being reproduced by a household personal computer.

It may be arranged that in FIG. 13A, music data compressed by a compression technique such as MP3, for example, is stored in the IC 7(7′), and high-definition music data is stored on the CD 2. If the user outdoors puts the card 10 into his or her portable player 100 with a CD card reader, the portable player 100 reads and reproduces compressed music (image) data from the IC 7(7′). If the user inserts the card 10 into the player 100′ at his or her home, the player 100′ reads and reproduces high-definition music data from the CD 2.

In this case, the portable player 100 may be configured so as to expand compressed music data. Alternatively, a card 10 with an IC 7′ that incorporates a microprocessor may be used so that compressed music data is expanded by the microprocessor in the IC 7′ based on an expansion program stored in the program area 74 (FIG. 3A).

Alternatively, a card 10, that has stored in IC 7 (7′) image data compressed by an image compression technique such as MPEG and that also has stored high-definition image data on the CD 2, may be set in a portable terminal (not shown) with a CD card reader and a display, so that compressed image stored in the IC 7(7′) is reproduced from the terminal. Also, the user can insert at his or her home the card 10 into a personal computer (not shown), which has a CD card reader, so that high-definition image data stored on the CD 2 can be read and reproduced.

In this case, the portable terminal may be configured so as to expand compressed image data. Alternatively, a card 10 with IC 7′ including a built-in microprocessor may be used to expand the compressed image data by the microprocessor, based on an expansion program stored in the program area 74 (see FIG. 3A).

4-\mathring{7} Method of Storing Game Data in the IC and Contents on the CD, and a Method of Using Stored Data

A card 10 is used for a card game (the card has game characters painted for collecting or exchanging purposes). The card 10 has printed on its front game characters, e.g., monsters that grow and change themselves with the progress of the game. Game data (parameters) of the game characters is stored in the data area of the memory 70(70′) of the IC 7(7′) of card 10.

When the card 10 is set in a portable game device (not shown) and the game device is turned on, game data stored in the IC 7(7′) changes with time according to the game program, and grown game characters appear on the display of the game device. A plurality of such game characters are stored. As the user manipulates the game device to let the characters fight against one another, the game characters learn fighting and become gradually stronger and bigger.

Because game data that changes with the progress of the game is written in the IC 7(7′), the user comes to possess a game card peculiar to the user. Thus, such CD cards containing game data on the pocket game characters can be collected or exchanged.

The CD 2 stores contents such as images and music, or other game data. Further, a card 10 with the IC 7′ including a microprocessor may be used to run a game program previously stored in the program area 74 (see FIG. 3A). In this case, the terminal is only required to display a result of the game (i.e., images). Therefore, a special-purpose game device is not required. In addition, the terminal and the card receiver are required to have a card access unit 31 (FIG. 4A) or a card reader 30 (FIG. 4A) to read data stored in the card 10.

In the mentioned above items 4-\mathring{1} to 4-\mathring{7}, applications of the card 10 have been illustrated, but they are not limited to those examples. For example, they may be used as a diary that has stored personal information or as a database regarding weather or stock prices.

### Security

As described above, various items of data can be stored, singly or associated with one another, in the card 10 including the IC 7(7′) and the CD2. In the use of the card 10, it is necessary to authenticate the user by checking if the user is qualified to use it, to maintain copy guard to thereby prevent the card 10 from being copied, to ensure security such as a copyright protector, to protect the copyright of contents stored in the card 10, and to control a valid usable count of a card and the number of times the contents stored in the card can be viewed.

FIGS. 4A and 4B show examples of card security data 120 and contents security data, respectively, stored in a security information area 72 in the memory 70(70′) of the IC 7(7′).

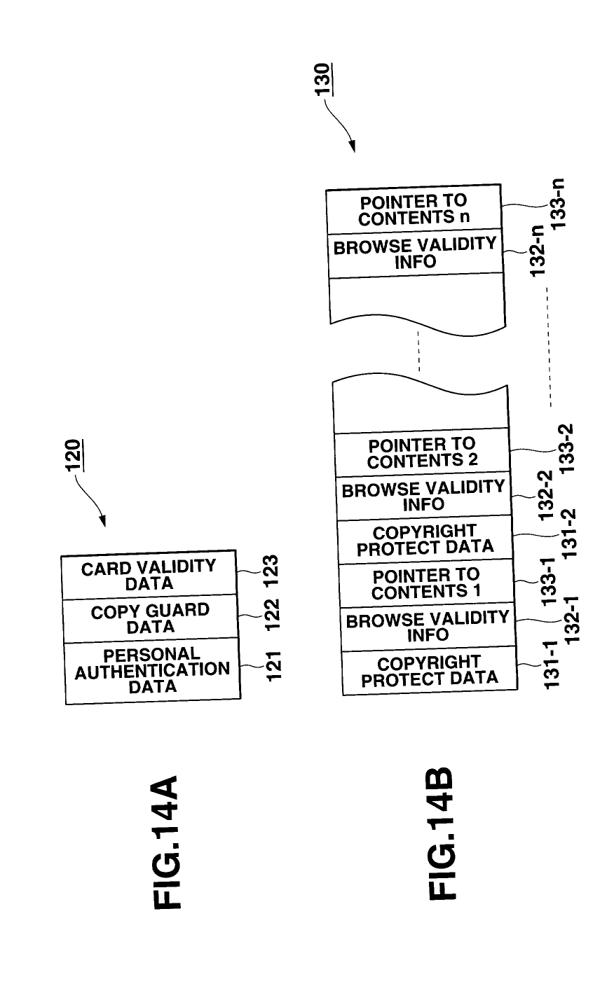

As shown in FIG. 14A, card security data 120 includes personal authentication data 121, copy guard data 122, and card validity data 123. The personal authentication 121 consists of encrypted image information such as a password or fingerprint that the user sets at the terminal when the user starts to use a card 10 for the first time.

The copy guard data 122 remains blank when the card is unused, but it stores a device number of a terminal under use inputted when the card is used first or copy prohibition information downloaded from the server through the Internet when the card is used first. (The copy guard data 122 may be flag information: “0” for “unused”; “1” for “used”.) Rewriting of the copy guard data 122 is prohibited.

Therefore, when the device number is set as the copy guard data 122 at the initial use of the card, the card 10 cannot be used at any other terminal even when its model is the same as that of the former card. When a registered number downloaded from the server is used as copy guard data 122, the card 10 can be used at another terminal. However, a card 10 produced by copying cannot be used at another terminal because the copy prohibition information is sent to the server when the card 10 is used for the first time.

Card validity data 123 is a numerical value, which is set as representing a predetermined number of times or count where free charge cards or over-the-counter cards can be used (a valid usable count of the card). It may be arranged that the number of times of use of each of cards sold by a vending machine is set at “0” before use and set as an actual value according to a purchase price of the card. By this arrangement, it is possible to prevent theft or illegal use of stolen cards.

As shown in FIG. 14B, contents security data 130 consists of contents copyright protection data 131, contents browsing validity information 132 and pointers 133 pointing to the contents stored on the CD 2.

Copyright protection data 131 is used to prohibit illegal copying of contents. The area for this data is blank when the contents are unused, and records copy prohibition information downloaded from the server through the Internet for each of contents files when the card is used for the first time. (Copy prohibition information may be a flag, which is “0” for “unused” and “1” for “used”.) Rewriting of the copy inhibition information is prohibited.

Therefore, the contents of the card 10 can be browsed even at another terminal within the valid number of times of browsing, but the copy prohibition information is sent to the server at the initial use of the card. Therefore, the contents of the card 10 cannot be copied at the terminal now under use or other terminals.

Browse validity information 132 of the contents is a value set as the number of times each of contents files can be browsed. The number of times of contents browsing can be renewed to the number of times of contents usage conforming to a charge for contents usage (10 times for ¥500, 12 times for ¥1000, for example) by following the specified procedures (by confirmation of reception of usage charge of contents, for example). Normally, for free contents, a special code (X′FF′, for example), which represents unlimited use is set. It may be arranged that the number of times free contents can be browsed is set for each of free contents files, that the set number of times is decremented by one at each browsing and that when the number of times of free browsing reaches zero, the card becomes inoperative. Then, it may further be arranged that the remaining free contents are switched to pay contents, and that the user can browse the contents up to a newly-set number of times by following the specified procedures (by charge payment). That is, for example, a product may be supplied as a free sample for the first use and then as a pay product from the second use on.

When copyright protection is not provided for each of titles of contents files and only the number of times each card can be used is managed, the browse validity information 132 for the contents is not required.

Writing copy prohibition information to the copy guard data 122 and copyright protection data 131 of the card security data 120 or checking of the copy prohibition information could be carried out by a security program installed in the terminal. If the security program is deciphered by somebody in that case, however, there are possibilities that the copy guard of the card 10 or the contents copyright protection will be broken and that the card or the contents will be copied illegally. However, a card 10 with the IC 7′ including a microprocessor and having a security program stored in the program area 74 of the memory 70′ thereof can be used and copy prohibition information can be written or checked in the copy guard data 122 and the copyright protection data 131 by the microprocessor in the IC 7′. In this case, the possibility that the security program in the IC 7′ will be deciphered is very lower than when the security program is installed in the terminal. Therefore, the likelihood of card copy guard or contents copyright being broken is greatly reduced, which results in effective prevention of illegal copy of cards and contents.

For copy guard data 122 and copyright protection data, electronic watermark may be used instead of copy prohibition information.

### Use of Recorded Data by Terminals Different in Access Method

In description of the examples 4-\mathring{1} through 4-\mathring{5}, reading the card 10 by a terminal with the access unit 31 that includes two access means (the access means 34 to the static memory IC 7(7′) and the access means 38, 39 to the CD 2 as the dynamic storage (see FIG. 4B) has been illustrated. In contrast, as described in the example 4-\mathring{6}, the IC 7(7′) may be accessed to read data by using a portable terminal in some cases, or the CD 2 may be accessed to read its data in a stationary terminal in other cases, depending on the environment in which the card 10 is used.

For example, save data, such as player information, is stored in the IC 7(7′) of the card 10, and a game program is stored on the CD 2. The user manipulates a portable game device (not shown) including a means to access the IC 7(7′) in the card 10 to play a game on the basis of the save data such as player information stored in the IC 7(7′). With a household game device equipped with two access means to access the IC 7(7′) and the CD 2 of card 10, it may be arranged that the user accesses the CD 2 to play a game in accordance with a game program on the CD 2 and that the progress of the game is stored in IC 7(7′). In this example, player ID codes (or pointers) are added to the player stored on the CD 2 and also to the player information stored in the IC 7(7′) so that the player information in the CD 2 is associated with the player information in the IC 7(7′).

B. Second Embodiment

1. Outline of Information Management System

In the second embodiment, digitized contents data (hereinafter referred to simply as contents), including character information such as information contained in dictionaries, literary works, guide books; image information such as information on maps, photos, illustrations, and paintings and sound information such as music are stored in card-type storage media such as CD cards. A card-type storage medium has a storage device provided on one side and prints on the other side. A storage medium having storage devices provided on both sides thereof may be used. In the first embodiment described above, the card 10 as shown in FIG. 1 may be used.

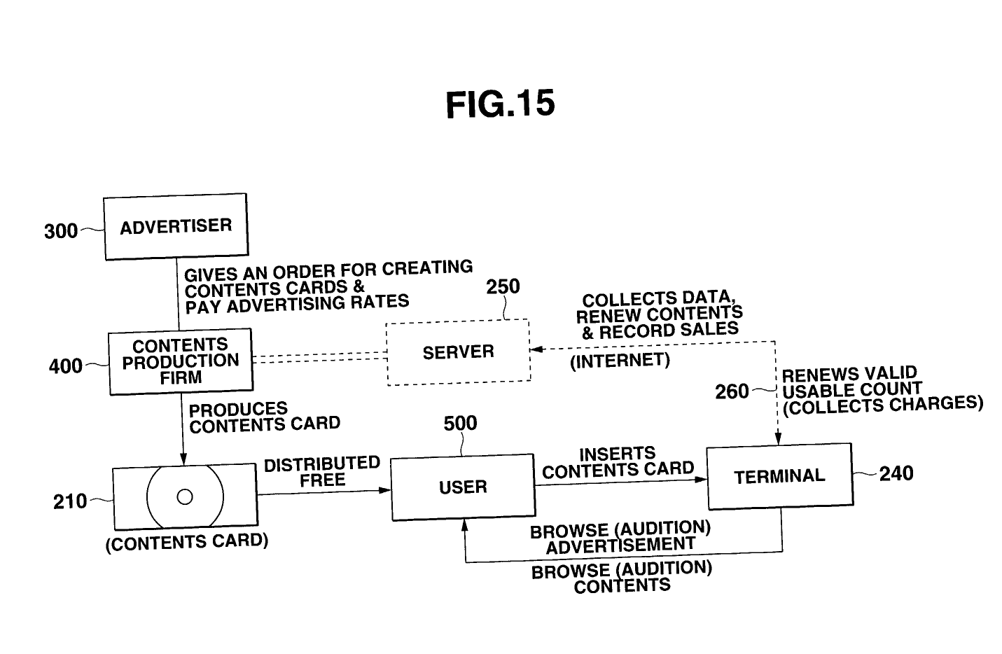

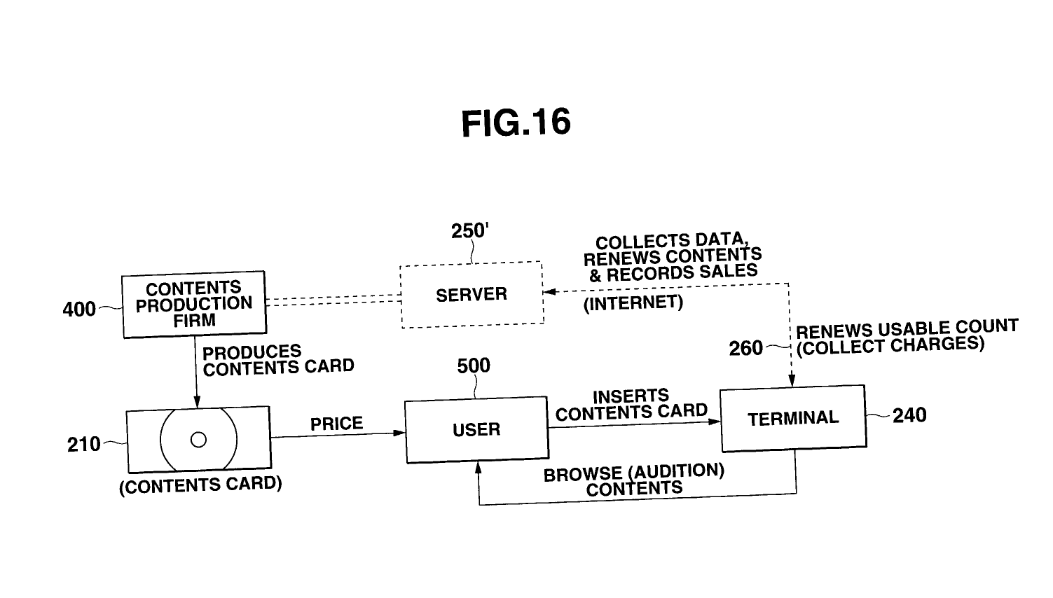

FIGS. 15 and 16 show different models of an information management system according to the second embodiment of the present invention.

The card-type storage mediums having stored free and/or pay contents data (Thus, it is hereafter referred to as a contents card) are distributed free of charge or sold as shown in FIGS. 15 and 16. A user, who possesses a contents card, can browse (or audition) the contents stored in the card simply by inserting it into the terminal.

As shown in FIG. 15, the contents cards 210 distributed free is used chiefly as advertising media, an advertiser 300 commissions a contents production firm 400 to create contents card 210 that contains contents including information for the advertiser's company's advertisement or service information such as music. The sponsor himself or herself distributes the cards or asks the production firm (or a firm specializing in distribution) to distribute the cards.

On the other hand, the contents production firm advertises for sponsors, creates and distributes the contents cards and receives advertising rates. The user can browse or audition the advertisement contents and on condition that the user replies to a questionnaire survey, also browse character information or images or music by simply inserting the contents card 210 into the terminal 240 (or it may be arranged that the user can view or listen to character, image or music information unconditionally).

In order to induce the user to pay service, it may be arranged that free contents are distributed generally, that the user is charged for use of the contents exceeding a set number of times (or a valid period), and that such use of the contents is recorded on the card as a sales amount.

In this case, the contents production firm may set up a server 250 to be connected to a network such as the Internet 260, collect numerical data on a situation of use of the card 210, and renew the contents.

As shown in FIG. 16, contents cards 210 may be sold over the counter just like dictionaries, books, magazines, and records, or may be sold through vending machines. By simply inserting a contents card 210 into the terminal 240, the user can view (or audition) the contents.

In this case, the contents production firm can supply various free or pay services through the server 250′ to be connected to a network such as the Internet 260, in addition to collecting numerical data on the situation of use of the contents card 260 and renewing the contents. Further, it may be arranged that when the number of times of card use (or a card's valid period) stored at a time of sale is exceeded, a charge for the surplus is collected (or asked), or that the sales amount is recorded. By replying to a questionnaire survey, the number of times of free card use may be increased, or the charge may be reduced. The server 250 or 250′ may either be installed by the contents production firm in FIG. 15 and 16 or may be a machine possessed by a managing entity (service firm) other than the contents production firm. The server may not be installed.

Embodiments of a contents card, a terminal and a network such as the Internet, that compose an information management system, will be described next.

2. Contents Card

2-(1) Contents Card with Storage Formed by an Optical Recording Medium

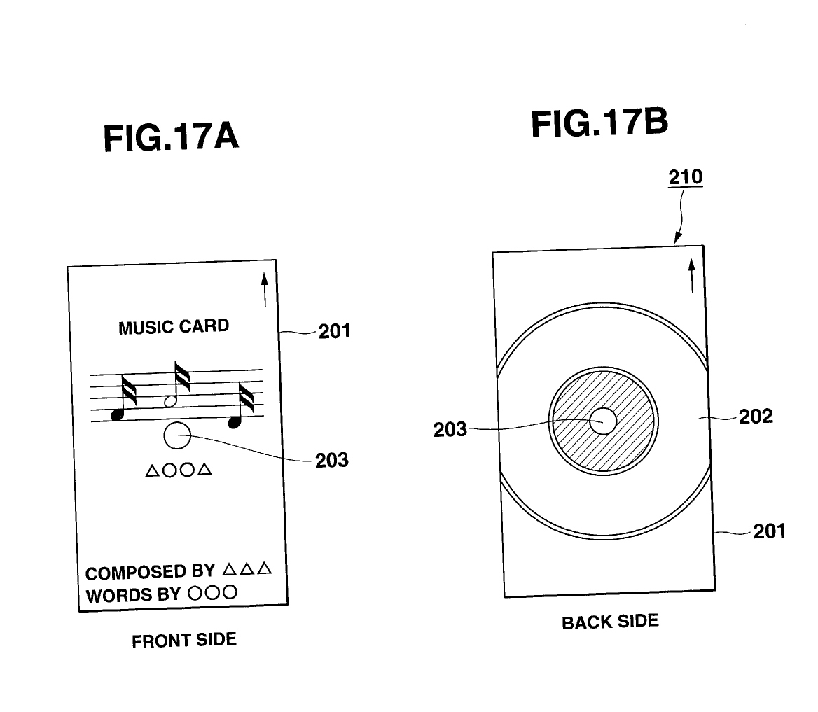

FIG. 17 shows one embodiment of a card-type storage medium (contents card) that has stored contents, taking the form of a non-circular optical storage CD card. In FIG. 17, reference numeral 201 denotes a substrate (made of a nonconductive material (synthetic resin or paper in this example)), 202 an optical storage area capable of optically storing information (and glued to or embedded in the substrate) and 203 a hole formed in the center of the card substrate 201. Note that in FIG. 17 a contents card 210 is shown which has an optical storage section 202 of non-circular optical storage tracks, but the optical storage section 202 may consists only of circular optical storage tracks.

In FIG. 17, the contents card 210 takes the form of a visiting card. The card has printed on the front side information representing the detail of contents stored in the optical storage section 202 (character strings and pictures; if the contents concern music, its title, the names of a composer and a singer, his or her photo, and the name of a production firm) as shown in FIG. 17A.

Further, an arrow mark (a guide for insertion) may be printed on the card, indicating the direction in which the card is inserted into the contents card device. Also, a notice may be printed to the effect that contents stored in the contents card 210 can be read simply by inserting the card into the contents card device, and that contents can be browsed (and auditioned) by inserting the card into an information-writing contents-card device.

On the back (or front) side of the contents card 210, as shown in the example of FIG. 17B, the optical storage area 202 is provided, which consists of non-circular optical storage tracks that have stored information required to use contents stored in the optical storage section 202 and contents of character information, sound information and image information.

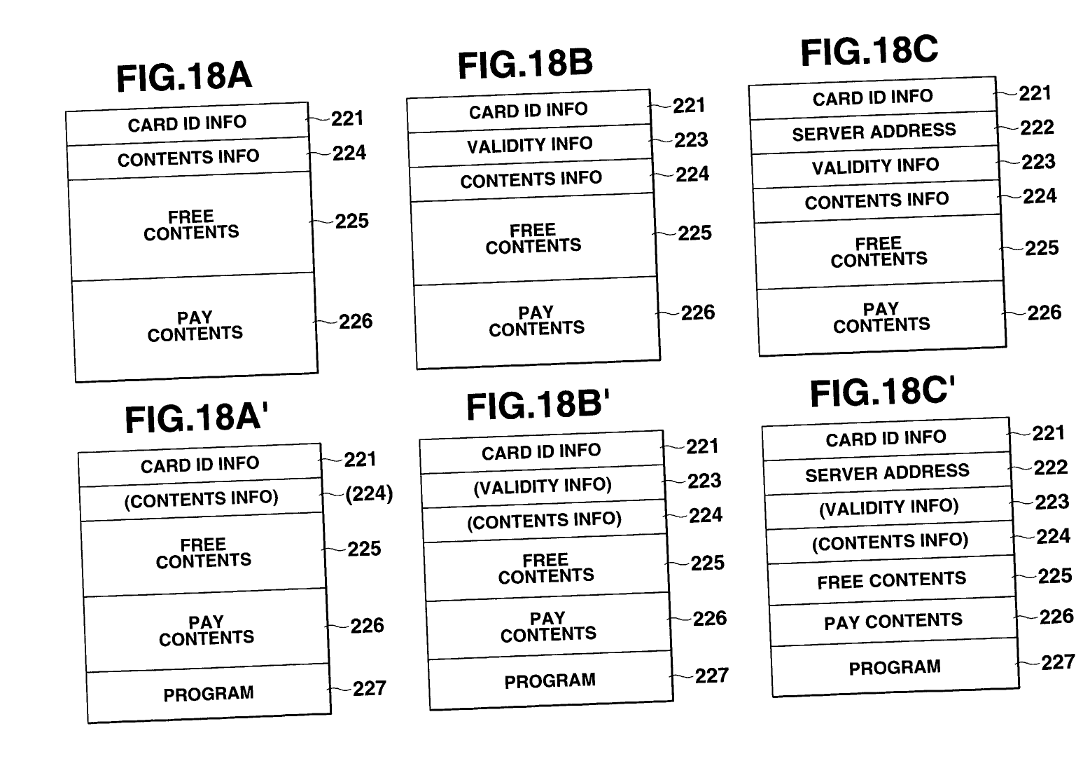

FIGS. 18A, B, C; A′, B′, C each show a composition of the optical storage area 202. In FIG. 17A, the optical storage area 202 consists of a card identification information area 221, a contents information area 224, a free contents area 225, and a pay contents area 226. The card identification information area 221 has stored card identification information such as a card number. The contents information area 224 has stored data on the kind, number, being free or pay, and storage address (track number, sector number) of contents. The free contents area 225 has stored free contents, and the pay contents area 226 has stored pay contents.

FIG. 18B shows an example that further includes a validity information area 223. The validity information area 223 stores validity information such as the number of times free contents can be used (browsing or output) or the number of times pay contents can be used. FIG. 18C shows an example that further includes a server address area 222. The server address area 222 has stored a server address which is required for charging for use of contents, gathering user information, and renewing the contents on the contents card with contents contained in a database.

While in the above examples the free and pay contents areas 225 and 226 are provided they are not restrictive. For example, a contents area may be provided, which stores only one of the free and pay contents.

FIGS. 18A′, B′ and C′ each show a program area 227 provided in the same optical storage area 202 as in FIGS. 17A, B and C for downloading contents on the terminal.

Programs stored in the program area 227 include programs for browsing (auditioning) contents at the terminal, such as a contents read program for reading into the terminal the contents (compressed data) stored in the contents data area 225, an expansion program for expanding compressed data, and a contents use count monitoring program for incrementing (decrementing) the number of times of use of free or pay contents based on the validity information 223.

In an example of FIG. 26, in which the terminal is connected via a network to the server, which will be described later, the program area 227 has stored, in addition to the above programs, all or some of other programs such as a network connection program, a display program for displaying read contents and/or an output program, a card driver which is used to read/write data from/to a contents card 210 inserted into the terminal, and a program for browsing (auditioning) the contents. Further, the area 227 may store a card driver for control of access to the terminal and a network automatic connection setting program for automatic setting to a network such as the Internet.

In FIGS. 18A, B, C; A′, B, C, if information on the contents card is not subject to renewal, the optical storage area 202 may include an unrewritable memory. If the contents card is configured such that information is renewable with data from the server as described later, the card number area 221 and the server address area 222 are made unrewritable, and the validity information area 223 through the program area 227 are made rewritable.

The free and pay contents areas 225 and 226 each can contain only one kind of contents, but normally contain a plurality of contents files. In this case, the free and pay contents are respectively stored in the form of a file in the contents areas 225 and 226.

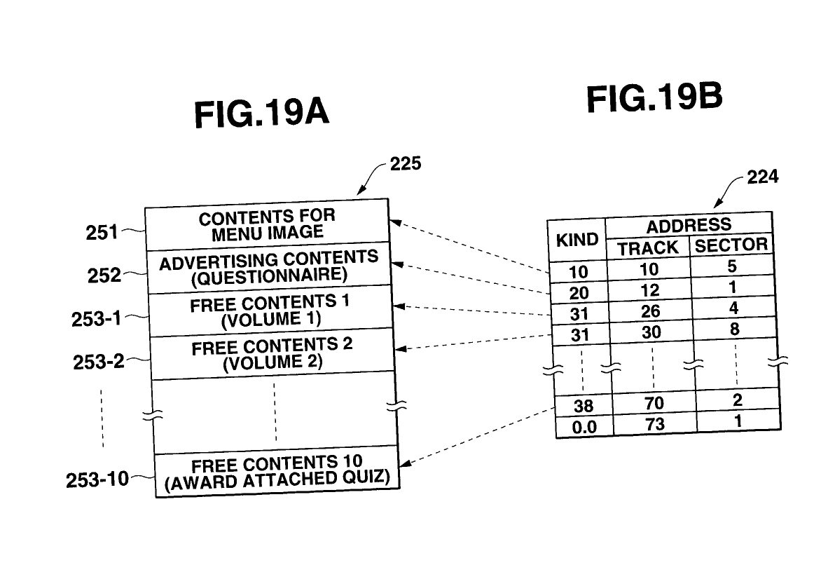

FIGS. 19A, B and 20A, B show other embodiments of the contents card. As shown in FIG. 19A, the free contents area 225 has stored a menu-picture contents file 251, an advertising contents file 252 (of questionnaire information, in this case), and free contents files 253-1 through 253-10. As shown in FIG. 19A, the pay contents area 226 has stored a menu-picture contents file 261, and pay contents 263-1 through 263-20 (songs, in this case). As illustrated, the free and pay contents are stored in the form of a file in the contents files 225 and 226, respectively. As shown in FIG. 19B, the kinds of the files (contents) and their storage addresses stored in the contents area 225 are also retained in a contents information area 224, and referred to by the card driver when the contents are read out.

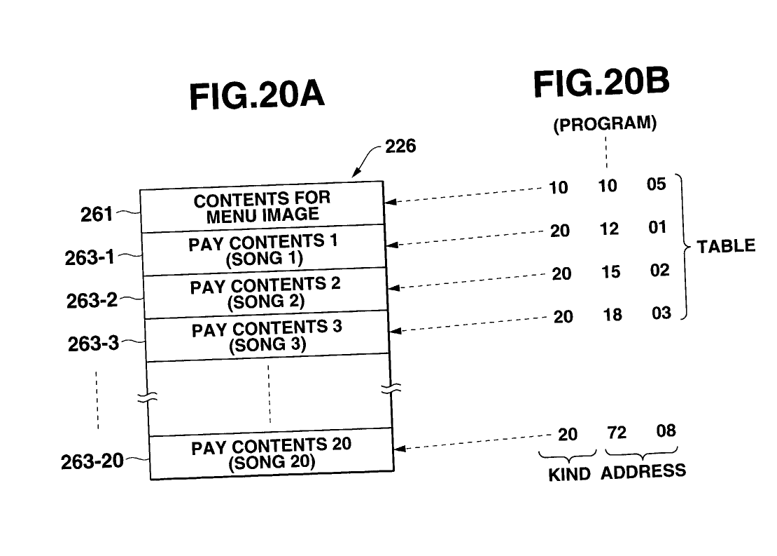

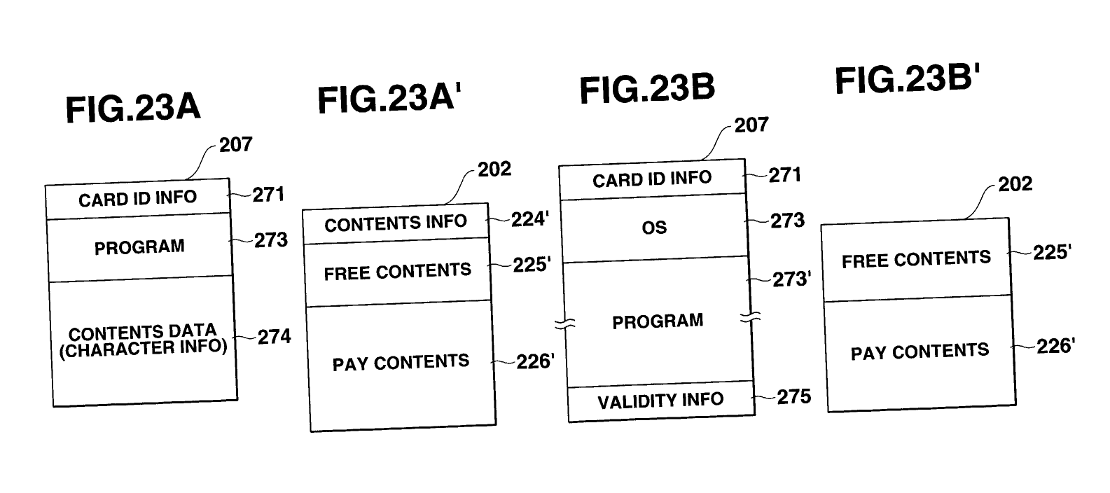

When the contents card 210 has the program area 227 which has stored programs (FIGS. 18A, B, C; FIGS. 23A, A′, B, B′), and if a table that has stored address information of respective contents files (FIG. 20B) is provided in the card driver as one of the programs, the contents information area 224 may be deleted.

### Examples of Contents Stored in the Contents Card 210 are as Follows

2-(1)-(A) Free Contents The free contents include advertising information, free music contents, synopses of novels and guide books, award attached quizzes, questionnaire survey, sightseeing maps, housing models, guidebooks regarding public services distributed by public bodies and so on (handy guide books for citizens, for example), and combinations of those contents.

The free contents are distributed by direct mail or as enclosures in notices sent from municipal offices, over the counter, as supplements to magazines, on the street or at the windows of banks and city offices.

Further, the contents card 210 may be distributed free in the form of a coupon ticket with which the stored contents can be used for a specified number of times (or a specified length of time). In this case, the number of times of free use (or a length of time of free use) of the contents is stored in the validity information area 223 shown in each of FIGS. 18B, C, B′ and C′. When the contents card 210 is used the specified number of times (length of time)for free use, the card is normally made unusable, but may thereafter be made pay.

Further, it may be arranged that the contents card 210 itself is made free of charge but the user pays or is charged for use of the contents.

2-(1)-(B) Pay Contents

Pay contents covers music and songs; electronic books as including novels, hobbies and cartoons, dictionaries, various guide books including tourist guides, guide books on folkways, archeology, and history, and books of award attached quizzes; traffic maps, city maps and other maps, transportation facilities maps; books of paintings on display sold at art exhibitions, and other books of fine arts which include sculptures and buildings. Those pay contents (sound information, character information, and image information, etc.) are supplied singly or in combination. The pay contents cards may be sold personally by mail or in vending machines. Further, they may be sold as gift certificates.

In this case, each contents file is made up of a main routine file, in which a synopsis of a whole story is written, and sub-routine files contain information representing required segments of the story in detail. For example, if a cartoon book is supplied as a combination of image information and sound information, the cartoon book file includes a combination of a main routine file describing a whole story of the book and sub-routine files comprising image and acoustic information.

2-(2) Contents Card including an Electronic Storage Medium and an Optical Storage Medium

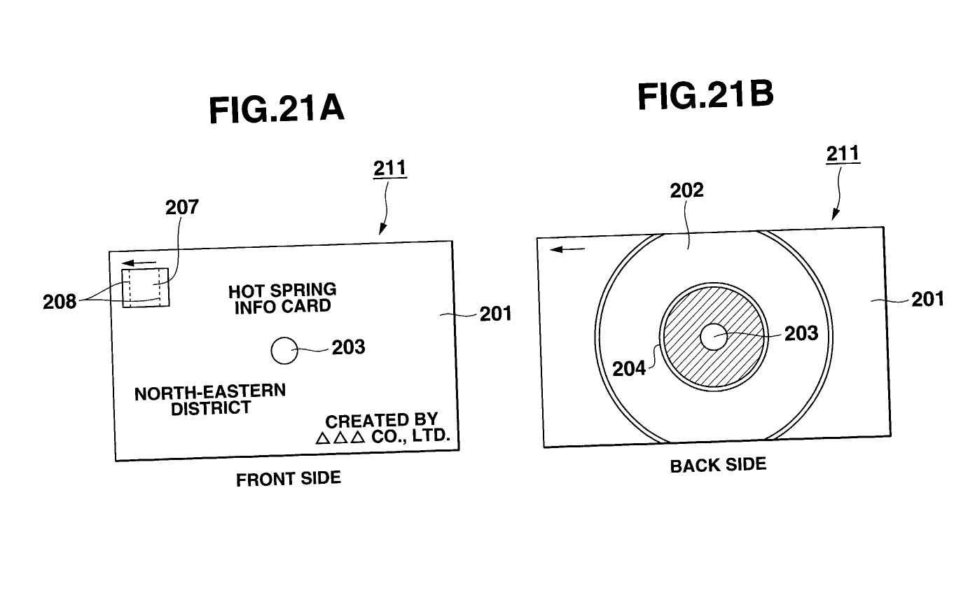

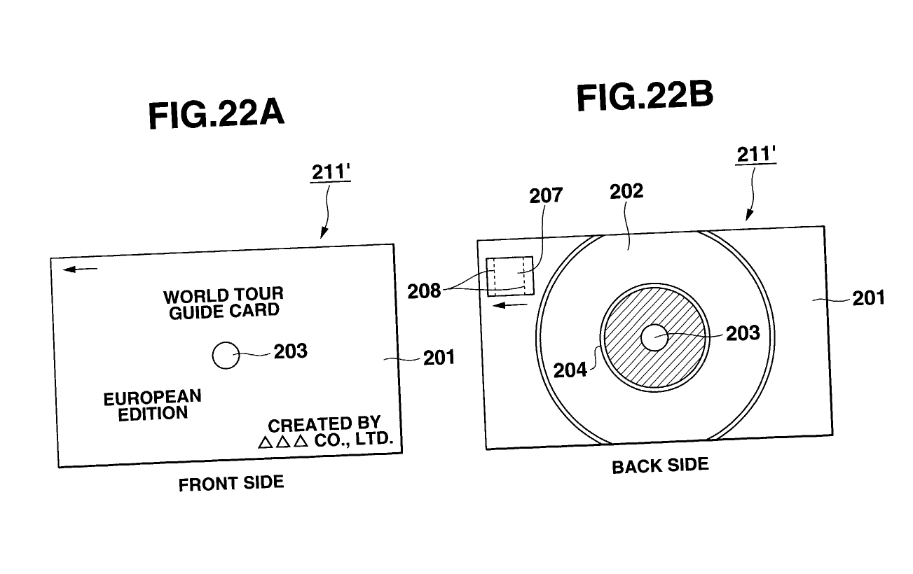

FIGS. 21A, B and 22A, B show other embodiments of a card-type storage medium that has stored contents. FIGS. 21A, B show an example of a contents card 11 which has an electronic storage device (an IC circuit glued or embedded) on the front side (or the back side) thereof and an optical storage area (a non-circular CD glued or embedded in this example) on the back side (or the front side) thereof. FIGS. 22A, B show an example of a contents card 211′, which has the electronic storage device and optical storage area provided on the same side.

In FIGS. 21A, B and 22A, B, reference numerals used are similar to those of FIGS. 17A, B. Reference numeral 201 denotes a substrate; 202 optical storage tracks for optically storing information; 203 a hole provided at the center of the substrate 201; 207 an electronic storage device; and 208 terminals for reading or writing therethrough information from or to the electronic storage device 207. In FIG. 21B, a contents card 211 is depicted which has an optical storage area 202 including non-circular optical storage tracks, but the optical storage area 202 may be made up of circular optical storage tracks.

In FIG. 21, the contents card 211 takes the form of a visiting card. As shown in FIG. 21A, the card 211 has an IC 207 embedded in the front (or back) side thereof, with printed information indicating the details of the stored contents (a character string or picture): in the case of a map for guiding hot spring resorts, the title of the guide, names and photos of the resorts, the name of the firm that produced the card on the front (or back) side. Like the embodiment mentioned above, an arrow mark may be printed on the card to show an inserting direction of the card into the contents card device or a note may be added to the card to the effect that the contents can be browsed (auditioned) simply by inserting the contents card 211 into the contents card device.

Provided, as shown in FIG. 21B, on the back (or front) side of the contents card 211 is the optical storage area 202 of non-circular optical storage tracks, which as described later (FIG. 23), has stored character information, sound information, image information, and information necessary for use of the contents stored in the optical storage area 202.

FIGS. 22A, B show that the contents card 211′ takes the form of a visiting card as in FIG. 21, and has printed on the front (or back) side thereof information indicating the stored contents therein (a character string and pictures: if the card presents information on a world tour guide, its title, photos of sightseeing sites, trip courses, and a card producer's firm name), as shown in FIG. 22A.

The IC 207 and the optical storage area 202 are provided on the back (or front) side of the contents card 211′ as shown in FIG. 22B. The IC 207 has stored information and a program necessary for use of the contents stored in the optical storage area 202. The optical storage area 202 has stored contents, such as character information, sound information and image information, which will be described later in detail (FIGS. 23A, A′: B, B′).

FIGS. 23A, A′, B, B′ show compositions of the storage area and device (examples of storage area layout) of the contents cards 211 and 211′ in FIGS. 21A, B and 22A, B. As shown in FIG. 23A, the IC memory 207 includes a card identification information area 271, a program area 273 and a contents data area 274. The card identification information area 271 has stored card identification information, the program area 273 has stored a program for downloading contents on the terminal, and the contents data area 274 has stored character information and simple information.

As shown in FIG. 23A, the optical storage part 202 has a contents information area 224′, a free contents area 225′, and a pay contents area 226′. The contents information area 224′ has stored the kind and number of contents and the storage address (a track number, a sector number) of contents. The free contents area 225′ has stored contents of image information, music information or detailed character information. The pay contents area 226′ has stored pay contents.

FIG. 23B shows an IC memory 207 of a type having a microprocessor and a memory, which includes a card identification information area 271, an OS area 272, a program area 273′ and a validity information area 275. The card identification information area 271 has stored card identification information. The OS area 272 has stored the OS (Operating System). The program area 273′ has stored programs such as a network connection program, a contents expansion program and an output program for outputting contents data to a buffer of the terminal. The validity area 275 has stored validity information such as the valid available number of times the contents can be used. As shown in FIG. 23B, the optical storage area 202 has a free contents area 225′ that has stored contents and a pay contents area 226′. In the example in FIG. 23B, instead of storing contents information in the optical storage area 202, a contents information table (see FIG. 20B) is provided in the card driver as one of the programs stored in the program area 273′. Thus, a contents information area is not provided in the optical storage area 202.

Examples of contents stored in the contents cards 211 and 211′ are as follows

2-(2)-(A) Free Contents

Like those free contents of 2-(1)-(A), examples of free contents in this case are advertising information, free music contents, outlines of novels and guide books, award attached quizzes, questionnaires, sightseeing maps, housing models, and guidebooks regarding public services distributed by public bodies, (for example, handy guide books for citizens), and combinations of those contents. By utilizing the fact that the storage medium has the electronic storage device (IC) 207 and the optical storage area 202, character information (a selective menu, advertising contents, merchandize information, a price list, purchaser names, ordering methods, etc.) may be stored in the contents data area 274 of the electronic storage area 207 on the front side (or on the same side as the optical storage area 202). The free contents may be stored in the optical storage area 202 on the back side (or on the same side as the electronic storage area 207.

Simple information (the outline of contents on the back side, for example) may be stored in the contents area 274 of the electronic storage area 207 whereas detailed information may be stored in the optical storage area 202 on the back side (or on the same side as the electronic storage device 207.

Those contents cards 211 and 211′ can be distributed in any one of the methods mentioned above. As in 2-(1)-(A), the contents stored in the contents cards 211 and 211′ can be distributed free as a coupon ticket that can be used free of charge for a specified number of times (length of time). As in 2-(1)-(A), the contents card 211 or 211′ themselves may be offered free, but the user may pay or be charged for use of the contents.

2-(1)-(B) Pay Contents

Like those in 2-(1)-(B), the pay contents in this example include contents of music and songs; electronic books as alternative media of conventional books including novels, hobbies, and cartoons; dictionaries; various guide books on folklore, archaeology, history, etc.; a collection of award attached quizzes; various kinds of maps such as traffic maps, city maps and transportation facilities maps; books of exhibited paintings available at art exhibitions; and other books of fine arts including sculptures and buildings. By making use of the features that the electronic storage part (IC) 207 and the optical storage part 202 together are provided on the card, character information (a selective menu, advertising contents, merchandise information, a price list, purchaser names, ordering methods, etc.) may be stored in the contents data area 274 of the electronic storage device 207 on the front side (or on the same side as the optical storage area 202), and pay contents may be stored in the optical storage area 202) on the back side (or on the same side as the electronic storage device 207). As in 2-(2)-(A) mentioned above, it may be arranged that simple information is stored in the contents data area 274 of the electronic storage device 207 whereas detailed information is stored in the optical storage area 202.

As in the contents cards for sale for pay in 2-(1)-(B), character information, image information and sound information in those contents cards 211 and 211′ are sold singly or in combinations. The contents cards may be sold in mail-order business or vending machines in addition to face-to-face sale, and may be sold as pay gift certificates.

3. Terminal for Browsing Contents Cards

3-(1) Content Card Device

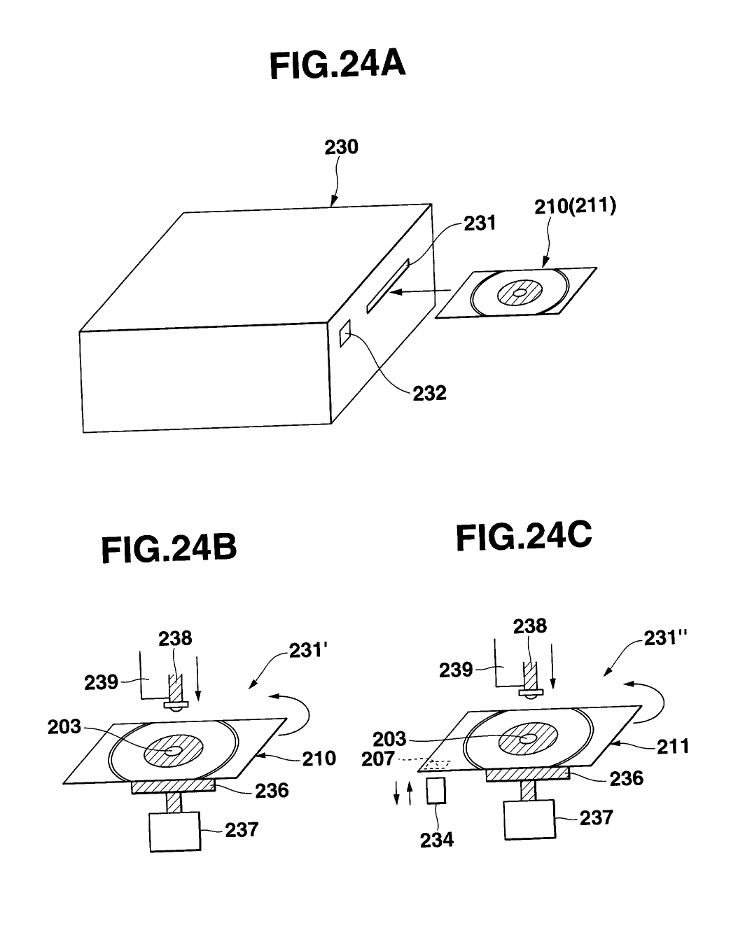

FIGS. 24A, B, C show one embodiment of the contents card device connected to (or built in) a terminal for browsing contents. FIG. 24A shows the appearance of a contents card device (in this example, a CD card device 230 configured so as to be accessible to a CD card 210 (211)). FIGS. 24B and 24C each illustrate a contents card drive and read/write operation.

3-(1)-(A) CD Card Device only Accessible to the Optical Storage Area

The CD card device has on its front an insert/eject slot 231 for a movable tray (not shown) for guiding thereon the CD card 210 into/away from the CD card device 230, and a movable tray drive button 232.

The CD card device 230 includes therein a CD card drive mechanism and a read/write mechanism 231′ as shown in FIG.24B. When the inserted CD card 210 is placed on a fixing table 236 of a card rotating unit, a shaft 238 descends along with an optical reader 239 to fix the CD card 210 to the fixing table 236. Then, the motor 37 rotates the fixing table 236 along with the CD card 210 placed on the table. The optical reader 239 reads information from the optical storage area 202 of the CD card 210 in accordance with a control signal from a CPU (not shown) built in the terminal or the card reader and outputs an electrical signal. If the optical storage area 202 (or its part) of the CD card is rewritable, the electrical signal (information) can be converted to an optical signal, which can be written to the optical storage area 202.

3-(1)-(B) CD Card Device Accessible to the Electronic Storage Device and the Optical Storage Area

The appearance of the CD card device used in this embodiment and its CD card inserting and ejecting operations are the same as in FIGS. 24A, B, C. The contents card drive mechanism and read/write mechanism 231″ each include an IC reader 234, which when the mechanism 231″ is at standstill, electrically contacts the IC 207 provided on the front side (or on the same side as the optical storage area) of the CD card to transmit and receive information to and from the IC 207.

When the CD card 210 (211) is fixed to the fixing table 236, the motor 237 is driven to thereby rotate the fixing table 236 and the CD card 210 (211) mounted on the table. The optical reader 239 reads information from optical storage part 202 of the DC card 210 (211) and outputs an electrical signal in accordance with control signals. If the optical storage area 202 (or its part) of the CD card 210 (211) is rewritable, the electrical signal (information) can be converted into an optical signal, which can be written into the optical storage area 202.

If the IC 207 is provided and when the CD card 211 is not rotating (in other words, when its rotation starts, stops or is already terminated), the IC reader 34 moves at a predetermined timing (thus bringing the terminals of the IC reader 234 into contact with the terminals of the IC 207 embedded in the underside of the CD card 211 in FIG. 24C), to read/write data (stored information) from/to the IC 207.

In other words, the CD card device 230 as shown in FIGS. 24A, B, C can be used as a data input device of a terminal such as a personal computer to read and reproduce data from the optical storage area 202 (and the IC 207) of the CD card 210 (211) so as to be used in a specified application.

FIG. 24C illustrates an internal mechanism of the terminal that reads information from the optical storage area 202 and the IC 207 provided on the opposite sides of the card. The terminal may be configured so as to read information (FIGS. 20A, B) from the optical storage area 202 and the IC 207 provided on the same side of the card, by disposing the IC reader 234 on the same side as the optical reader 239.

While in the example of FIGS. 24A, B, C the single-unit type card device 230 is shown which reads data from the optical storage area and reads/writes data from/to the IC 207 of the CD card 211, the card device is not limited to this type. For example, a CD card device may be used to read data from the optical storage area 202 of the card 211 by rotating the CD card 211, whereas an IC read/write device separated from the CD card device may be used to read data from the IC 207 of the card.

3-(2) Terminal Device foBrowsing the Contents Card

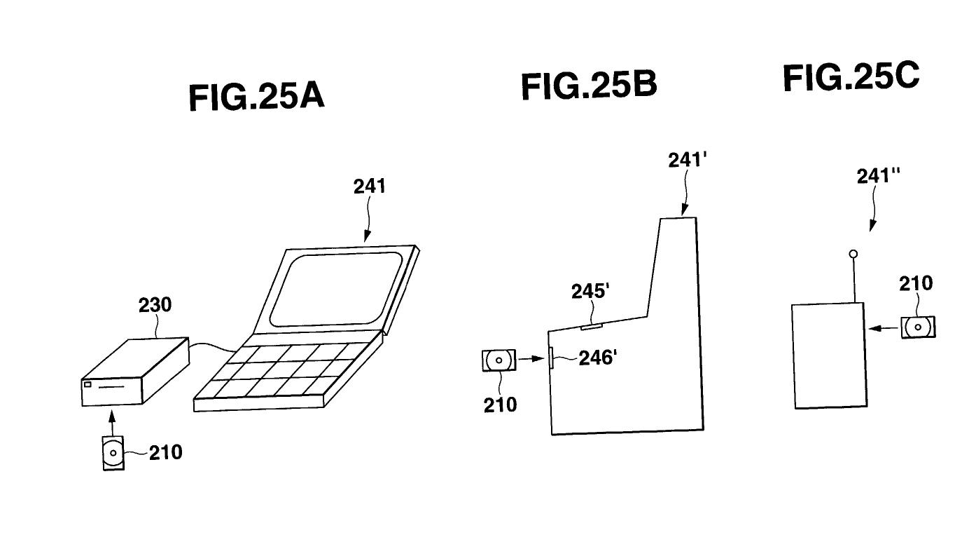

FIGS. 25A, B, C each show an example of a terminal for browsing a contents card. In one example, a CD card device 230 accessible to the CD card 210 (211) is connected to, or built in, the terminal.

As shown in FIGS. 25A, B, C, terminals that browse a contents card include a personal computer 241, and a CD card device 230 of FIG. 24A connected to, or built in, the personal computer 241; a stationary terminal 241′ that has therein built a CD card device 230 such as shown in FIG. 24A and is installed in a place where people are easy to collect, for example, a station, supermarket, department store or convenience store (FIG. 25B); and a portable-type mobile terminal (a personal digital assitant or a portable telephone) 241″ that has therein built a CD card device 230 (FIG. 25C).

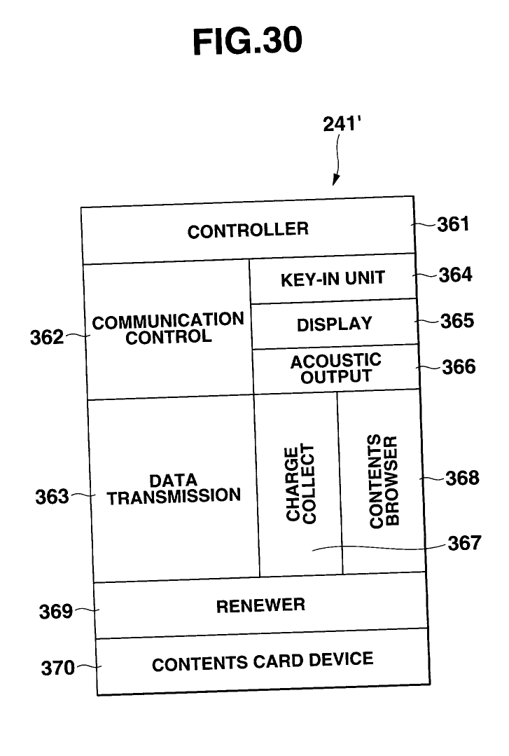

The personal computer 241 is equipped with a sound output unit. The stationary terminal 241′ comprises a computer that includes a plurality of operation keys, a display monitor, a sound output unit, a charge collection mechanism (367 in FIG. 30) including a charge collection slot 245′, and a card insert/discharge slot 246′. As described later (FIGS. 27A, B; 30), those terminals may be used not only for browsing contents cards, but also for selling contents cards, renewing the valid number of times (or a valid period) of use of contents, renewing the contents, and collecting data on a result of a questionnaire survey. The portable-type mobile terminal is equipped with a display monitor and a sound output unit.

As shown in FIG. 15 or 16, when the CD card 210 (211) is inserted into the CD card device 230, the terminal 241, 241′ or 241″ reads contents from the CD card 210 (211) and stores the contents into a buffer memory of the terminal, displays data on the monitor for browsing purposes, and audibly outputs the data simultaneously or at a specified timing.

Further, as shown in FIG. 15 or 16, if the terminal 241, 241′ or 241″ is connectable to a network such as the Internet (the Internet 260 in this example) and when the contents card 210 is inserted into the terminal 241, 241′ or 241″, the appropriate terminal is connected to the server 250 (250′). The server 250(250′) can charge the user or the advertiser for services offered by the server, transmit a contents card browsing program, and renew the contents.

The stationary terminal of FIG. 25B may be configured to have a charge collection slot 245′ and a charge receiving device (not shown) so that the user can insert the CD card 210(211) into the slot after throwing in a proper charge to thereby browse pay contents (or after inserting the CD card and throwing in a proper charge, the user can browse corresponding pay contents).

3-(3) Arrangement of a Contents Card Browsing Program

The contents browsing program can be arranged in different places as follows:

\mathring{1} A card driver consisting of programs for control of access to a contents card and a program for browsing a contents card have been installed in the terminal. That is, the terminal has been set so as to be connectable to a network such as the Internet and both an Internet connection program such as a WWW browser and the browser program for contents cards have been installed in the terminal;

\mathring{2} A card driver and contents browsing programs have been stored in the contents card. More specifically, a card driver, a connection program to connect to a network such as the Internet, contents-card browsing programs and an automatic connection-establishing program for a connection between the terminal and a network such as the Internet have been stored in the program area 227 in FIGS. 18A′, B′ and C′. When a contents card is inserted into the terminal, the terminal extracts programs from the contents card:

\mathring{3} The server 250(250′) (FIGS. 15 and 16) possesses a card driver, a connection program to connect to a network such as the Internet, contents-card browsing programs, and an automatic connection-establishing program for connection between the terminal and the network. After a contents card is inserted into the terminal and when the server is connected to the terminal via the Internet, the programs are downloaded from the center machine 250(250′) to the terminal;

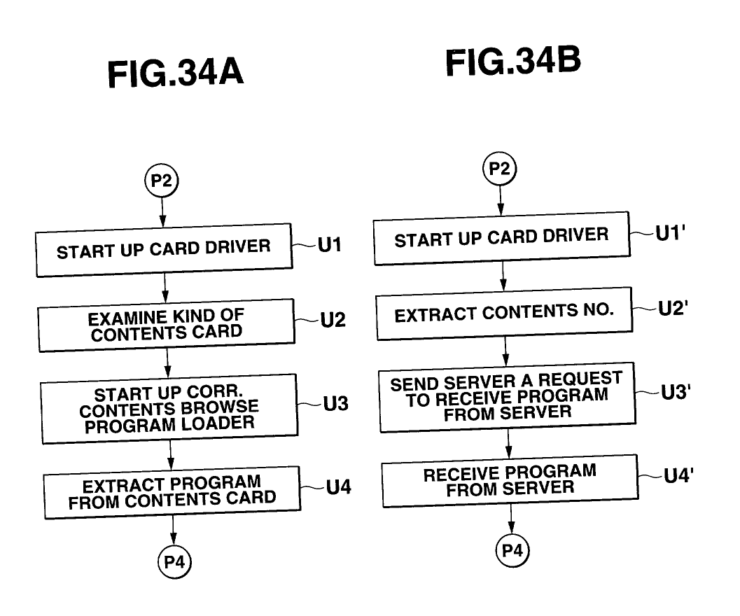

\mathring{4} A card driver has been installed in the terminal, and a connection of the terminal with the network has been established. Contents-browsing programs are provided in the contents card or the server 250(250′). In this case, the terminal extracts the browsing programs from the contents card or downloads them from the server 250(250′) (step P3 in FIG. 27); FIGS. 34A, B):

\mathring{5} A microcomputer is provided in the contents card whereas a card driver, a connection program to connect to a network such as the Internet, contents-card browsing programs, and an automatic connection-establishing program to establish a connection from the terminal to the network are stored in the program area 273′ in FIG. 23B.

In the case of \mathring{1}, since the contents-card browsing programs have been installed in the terminal, the user can browse a contents card simply by inserting the card into the terminal. If a program for browsing a contents card varies depending on the kind of the contents card, it is necessary to previously install those programs for browsing contents cards corresponding to the kinds of contents cards. The card driver is required to have versatility, which imposes a very high load on the memory of the terminal.

Therefore, the case \mathring{1} is suitable for the terminal 241′ dedicated to browsing a contents card as shown in FIG. 25B. However, if the personal computer 241 is used as a terminal for browsing a contents card in FIG. 25A and if the mobile terminal 241″ is used as a terminal for browsing a contents card as shown in FIG. 25C, an increased load is imposed on the program memory. Renewing the contents card browsing program can be troublesome as the case may be.

In contrast, in the case \mathring{2} the terminal is required to have a program loading means (program) to extract the contents card browsing program from the contents card and to write the program into the RAM. The RAM can beforehand store a card driver dedicated to the contents card and a browsing program for the stored contents. The problem seen in the case \mathring{1} will not occur. A decrease in the storage capacity efficiency of the contents card is prevented.

Also, even in the case \mathring{3} the terminal is required to have a program upload means (program) that receives the contents card browsing program from the sever 250 and writes the program into the RAM. Since the RAM can also beforehand store a card driver dedicated to the contents card and a browsing program for the stored contents, the problems seen in the case \mathring{1} will not occur. A decrease in the storage capacity efficiency of the contents card is prevented.

Since the terminal has installed the card driver therein in the case \mathring{4} and the contents card or server 250 (250′) has stored the contents browsing programs, the terminal can acquire or receive the card driver in a short time to thereby shorten the overhead time. A decrease in the storage capacity efficiency of the contents card is prevented.

Since in the case \mathring{5} the contents card connects via the terminal concerned to the network and prepares to browse the contents, the terminal is required to have a buffer memory used for sending/receiving data to/from the network, a display buffer memory for browsing purposes, and/or an acoustic output buffer memory. Thus, the problem seen in the case \mathring{1} will not occur. Especially, this case \mathring{5} is suitable for browsing the contents card in a mobile terminal having a small memory capacity.

While in the above descriptions the CD card device is illustrated as a contents card device that is connected to, or built in, the contents card browsing terminal, the contents card device is not limited to the CD card device (for example, the contents card device may be an IC card device accessible to an IC card that includes an IC embedded therein or attached thereto. Alternatively, it may be a DVD device that reads data stored on a DVD or an MD device that reads data stored on an MD).

4. Information Managing System Using a Network

4-(1) Composition

FIG. 26 illustrates a composition of one embodiment of a network system including an information managing system according to the present invention. The network includes the Internet 260. As an example, the network system 600 comprises a server 250 (250′) with a database 280 (FIG. 28) connected to the Internet 260, a plurality of user terminals (personal computers) 241 (FIG. 25A) connected to the Internet 260 through a server 262, and a plurality of stationary terminals 241′ connected via a server 264 to the Internet. A plurality of mobile terminals 241″ may be connected wirelessly to a server 263 that is connected to the Internet 260. A network system 600 may be constituted so as to include the server 250 (250′) connected to the Internet 260 and the plurality of mobile terminals 241″ connected to the Internet 260 via the server 263.

4-(2) Sales of Contents Using a Network

A method of selling pay contents on a contents card using the network system of FIG. 26 will be described based on a flowchart of FIGS. 27A and B. It is assumed that the terminals 241, 241′ and 241″ each comprise a card driver installed therein and that a contents card (CD card 210, 211 or 211′) has stored programs necessary for browsing the contents (FIGS. 18A′, B′ and C′; FIG. 21A).

Step P1 (Acquisition of Contents Card)

In FIG. 27A, the user acquires a free contents card from free distributions or supplements to magazines, or enclosures of direct mails, or buys a pay contents card 210, 211 or 211′ from a contents card selling machine (or a stationary terminal) (FIG. 25B). These contents cards are shown in FIGS. 17A, B; FIGS. 21A, B; FIGS. 22A, B.

Step P2 (Use of Contents Card)

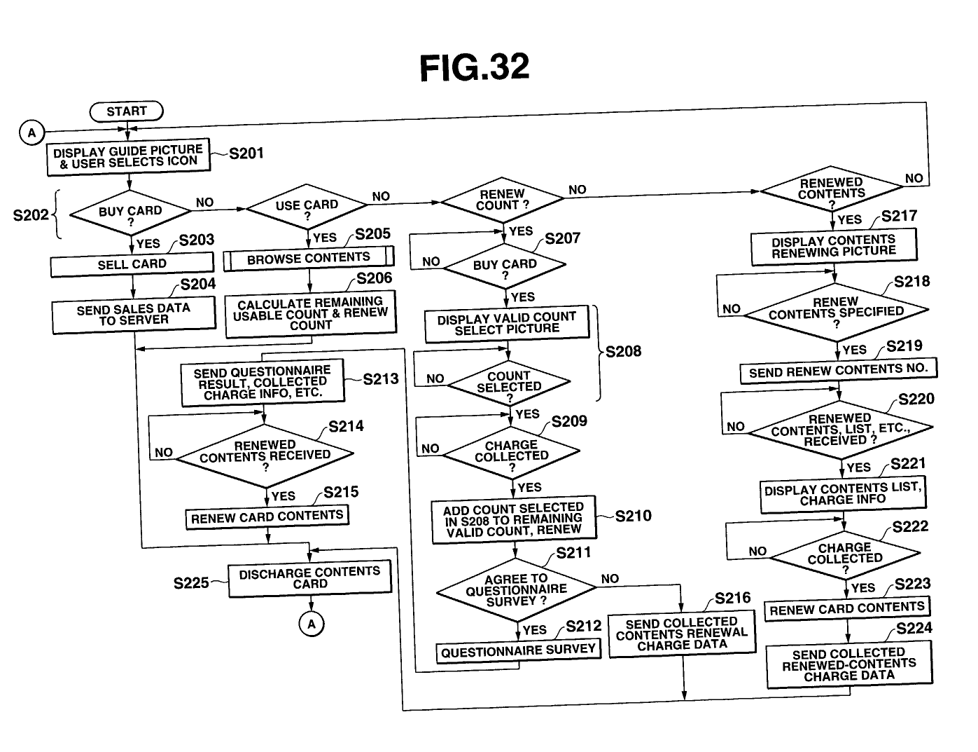

When the user desires to browse (audition) contents stored on the contents card, the user starts up any one of the terminals 241, 241′ and 241″ and inserts the card into the started-up terminal. When the terminal 241′ is used, a menu “Contents Browse” should be selected from the displayed menu (FIG. 32).

Step P3 (Extract Contents Browsing Program)

When the contents card is inserted into the terminal, the card driver, which is already installed along with the Internet connection program in the terminal, extracts the contents browsing program stored in a program area 227 (271) of the card and stores it in the RAM of the terminal (FIG. 32). Alternatively, arrangement may be such that the card driver, Internet connection program and contents browsing program stored in the contents card are read out for utilizing purposes. Also, alternatively, the card driver beforehand installed in the terminal may read the Internet connection program and contents browsing program stored in the contents card for utilizing purposes.

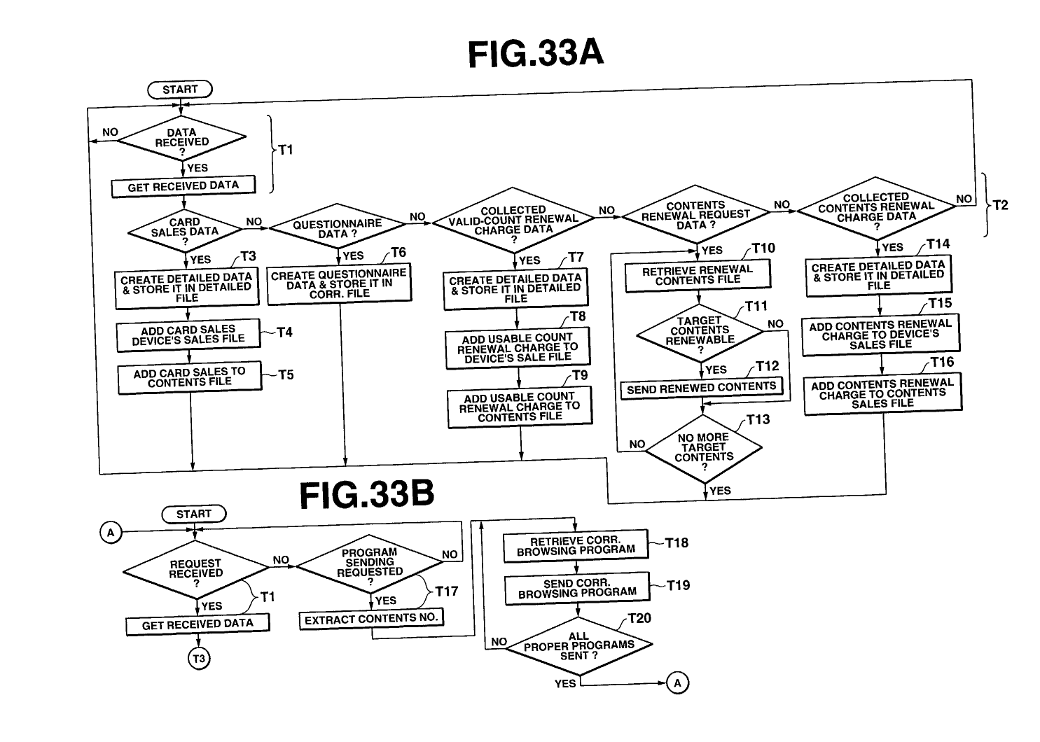

Further, alternatively, the card driver and the Internet connection program may be installed in the terminal and the contents browsing program may be downloaded from the server 250 (250′) to the terminal. The card driver, the Internet connection program and the contents browsing program may be downloaded from the server 250 (250′). Furthermore, alternatively, the card driver may be installed beforehand in the terminal, and the Internet connection program and the contents browsing program may be downloaded from the server 250 (250′) (FIG. 33B).

Step P4 (Selection of Pay Contents Browsing)

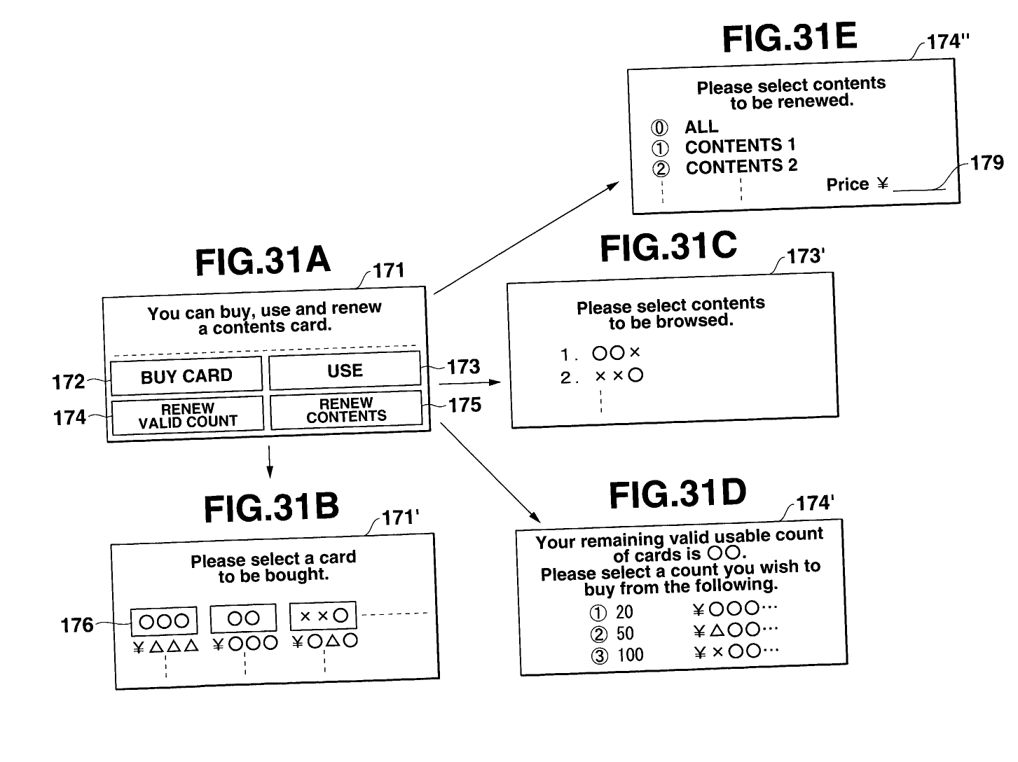

When the user selects browsing of pay contents in a contents selection menu (FIG. 31C) displayed by the contents browsing program, the control passes to step P6.

Step P5 (Selection of Free Contents Browsing)

When the user selects browsing free contents in the contents selection menu (FIG. 31C) displayed by the contents browsing program, the control passes to step P7. If otherwise, the processing ends.

Step P6 (Determination of a Remaining Valid Usable Count in the Card)

The terminal examines the remaining valid usable count of the card stored in a valid area 223 based on the browsing program. If the remaining valid count is larger than zero, the control passes to step P7. If otherwise, the control passes to step P8. When a card having no validity information area 223 (FIG. 18A′) is read, the control passes to step P7.

The use of the validity information stored in the validity information area 223 is not limited to the valid usable count of the card, but may be used for a valid usable term of the card. If the validity information is on the valid usable term of the card, it is determined whether the present date is within the valid usable term of the card in step P6. If it is, the control passes to step P7. If otherwise, the control passes to step P8. If the validity information involves the term of use of the card, the present date and the remaining hours when the card can be used are checked in step P6. If the remaining usable time of the card is larger than zero, the control passes to step P7. If otherwise, the control passes to P8.

Step P7 (Contents Browsing)

When it is confirmed in step P6 that the card is valid, the terminal reads contents information (FIGS. 18′, B′ and C′) stored in the contents information area 224, using the browsing program, extracts menu picture contents 251, and displays a corresponding menu. When the user selects a desired menu item, the terminal reads contents corresponding to the selected menu item from a free contents area 225 (225′) or a pay contents area 226 (226′) of the contents card, expands the contents, and then displays the contents on the display 165 or outputs audibly from the acoustic output 166. At this time, when the user terminates the contents browsing operation, the terminal writes a value representing the valid count minus one over the validity information area 223 (or renews the data stored in the validity information area 223 with the remaining valid usable count. Step P11 is next. If the contents card has no validity information area 223, the valid usable count is not decremented. When the validity information involves the valid usable hours of the card, the terminal writes a value representing the original valid usable hours minus the hours used (the remaining valid usable hours) over the validity information area 223.

Step P8 (Selection of Valid Count Recovery)

When it is confirmed in step P6 that the card is invalid, the terminal displays on the display monitor a method and charge for renewing the valid count based on the browsing program. When the user desires the “valid count renewal”, the user comes to a nearby stationary terminal and renews the valid count in step P10 (when no valid count is renewed, the contents card cannot be used. Thus, the card is discarded by the user). When the valid term of the card expires or the valid usable hours of the card is smaller than predetermined hours, the card is discarded similarly.

Step P9 (Preparation for Renewal of Card by Stationary Terminal)

Since the stationary terminal 241′ displays a guide picture 171, as shown in FIG. 31A in step P8, the user selects an icon “Renew valid count” 174, and then inserts the contents card into the card receiver 246′ in the stationary terminal 241′. In response, the terminal 241 displays a picture 174′ where selectable valid usable counts of the card to be renewed, and corresponding renewal charges are as shown in FIG. 31D. The user selects a desired count with keys or the like.

Step P10 (Renewal of the Valid Usable Count of Card)

When the user inserts a coin or bill (or note) corresponding to the selected renewal charge selected in step P9 into insert slot 245′ (FIG. 25B), the stationary terminal 241′ adds an valid usable count corresponding to the paid amount of money to the valid information area of the contents card.

Step P11 (Determination of Browse End)

When the user terminates the browsing operation, the contents browsing program terminates the browsing process. When the user browses the next contents, the control passes to step P4.

In the step of FIG. 27, the contents production or sales firm 400 can sell the contents stored on the contents card in advance payment based on the renewal of the valid usable count (term or hours) of the contents card in the stationary terminal 241′ (steps P7 and P8).

When the contents are sold, the sales (collected price) is sent to the server 250 (250′). Thus, the server 250 (250′) can periodically sum up the sales volumes for each of contents files. Also, a dividend to be paid to the owner of the stationary terminal 241′ can be calculated periodically, for example, monthly. In addition, a questionnaire and the card identification information are sent to the server 250 (250′). Thus, the contents production firm can grasp the situation of contents use, plans contents production, determines advertisement rates, and creates a report to be sent to advertisers.

As shown in the flowchart of FIG. 27B, it may be arranged such that free contents can be browsed a predetermined number of times over which the contents are changed to pay ones. Thus, when the user selects the free contents in FIG. 27A (step P4→P5), a message appears that includes “You can enjoy browing the free contents a predetermined number of times from now, but the contents are then changed to pay ones. You can continue to browse the contents if you agree to the change of the free contents to pay contents. If otherwise, you cannot any longer continue to enjoy browsing the contents after browing a predetermined number of times. You are requested to determine whether to agree to the change of the free contents to the pay contents” (step P5-2) If the user selects the pay contents, the controller rewrites information on the free contents of the contents information 224 (FIGS. 18A, B, C; A′, B′, C′) from “free” to “pay”. The control then passes to step P8 (step P5-3).

When the user does not agree to the change from the free contents to the pay contents in step P5-2, the number of times of use (usable count) of the free contents in the validity information 223 (FIGS. 18A, B, C; A′, B′, C′) is render zero after the free contents are browsed the predetermined number of times and the free contents are rendered unusable (unbrowsable) (step P5-4).

In order to prevent unjust use of the count of the card in the process of FIG. 27, the remaining valid count (or hours) obtained in step P3 may be written over a predetermined one of the constant-number areas for the programs stored in the program area 227. When a value in the constant-number area does not coincide with the data in the validity information area 223 in the card validity determination in step P4, the contents card may be invalidated as an unjust card. The valid count may be managed by the server 250 (250′) via the Internet 260 without providing such validity information area in the contents card. In this case, starting-up of the Internet connection program and establishment of communicative connection between the stationary terminal 241′ and the server 250 (250′) through the Internet 260 should be made in step P3 or between steps P2 and P3.

4-(3) Composition of the Server used in the Network

FIG. 23 illustrates a composition of the server 250 (250′), which comprises a controller 251, a communication control 252, a data transmission unit 253, a data input/output unit 254, a sales data recorder 255, a questionnaire data recorder 256, a contents renewer 257, and a sales spread sheet/other creator 258.

Controller 251 comprises a CPU, a RAM, a program storage memory and peripheral circuits. The communication controller 252 controls communication between the controller 251 and the Internet 260. The data transmission unit 253 comprises a plurality of reception buffers each for receiving data from a respective one of a plurality of stationary terminals and sends renewed contents to the stationary terminal. The data input/output unit 254 accesses the database 280. The sales data recorder 255 records sales amounts of the cards and their contents in a file of sales amount 281 of each device or terminal and a file of sales amount by contents type 282, respectively, to create detailed data to be written into a detailed data file 283. The questionnaire data recorder 256 creates file data to be written into the questionnaire file 284 based on a result of a questionnaire survey concerned. The contents renewer 257 renews contents stored in contents files 285-1 to 285-n. The spread sheet/others creator 258 creates a sales spread sheet and a sales trend survey table based on the file of sales amount 281 of each device or terminal and the file of sales amount by contents 282, and also creates a user's usage trend analysis table based on the questionnaire file 284.

The communication controller 252, data transmission unit 253, sales data recorder 255, questionnaire data recorder 256, contents renewer 257, and sales spread sheet/others creator 258 may be created by corresponding programs and stored in the program storage memory so that they can be executed under control of controller 251.

The server 250 (250′) may be connected to the database 280 directly or via the Internet 260. The database 280 comprises the files of sales amount 281 of the respective devices or terminals, files of sales amount by contents type 282, detailed-data file 283, questionnaire file 284, and contents files 285-1 to 286-n. The file of sales amount 281 of each device or terminal stores a sales amount (its collected price) by stationary terminal 241′ connected to the server 250 (250′) via the Internet 260. The file of sales amount by contents type 282 stores a sales amount by contents type (its collected price). Detailed-data file 283 stores data on the details of the sales amount and renewed usable counts (of contents). The questionnaire file 284 stores a result of the questionnaire survey. The contents files 285-1 to 285-n each store data on the contents. In the case of a system in which the browsing program 286 is sent from the server 250 (250′) to a terminal into which the contents card is inserted, browsing programs 286 should be stored in the database 280. When a WWW browser is used as the browsing program in the Internet, the programs each may be composed of a HTML file and the contents files 285-1 to 285-n may each be a data file related to a HTML file.

4-(4) Composition of the Database

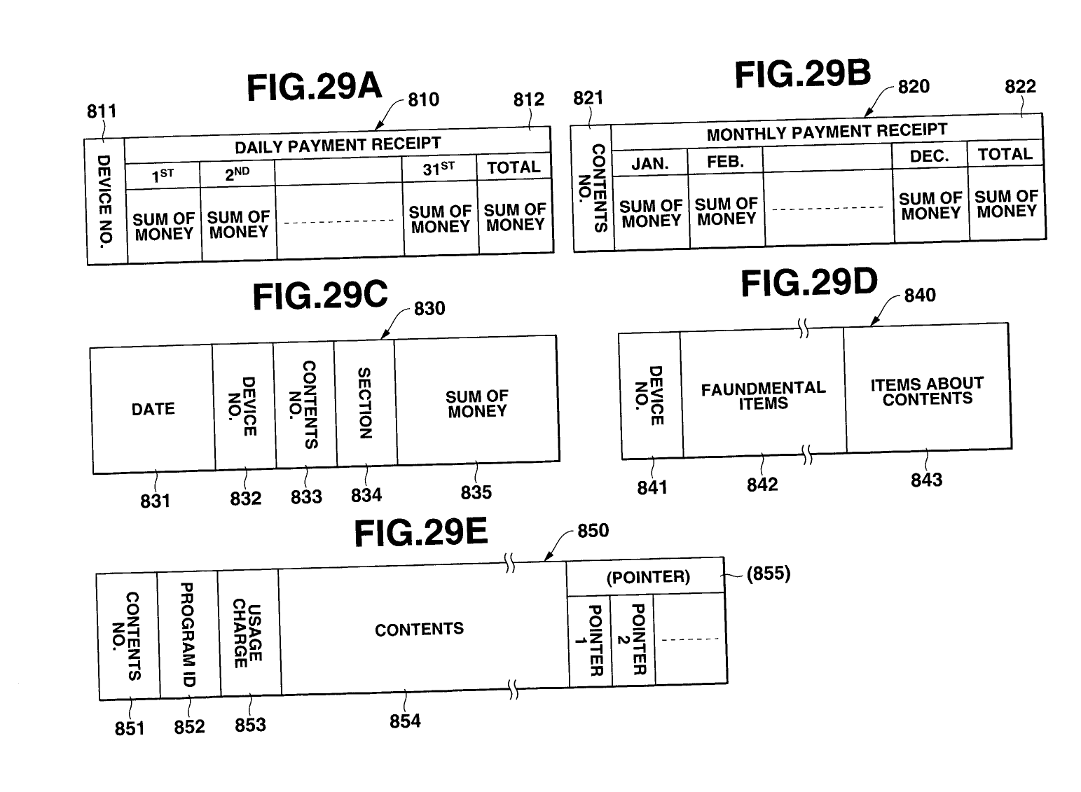

FIGS. 29A-E each illustrate a composition of data stored in each of the files stored in the database 280. As shown in FIG. 29A, data on a file of sales amount 810 of each device or terminal comprises a device number column 811 that stores a device (or ID) number of a stationary terminal 241′ and a daily payment receipt list 812 that stores a daily payment receipt amount (sales) for each terminal 241′.

As shown in FIG. 29B, data on a file of sales amount by contents type 820 comprises a contents No. column 821 that stores a contents No. (or ID No.) and a monthly sales column 822 that stores a monthly sales of contents.

As shown in FIG. 29C, the detailed-data file 830 comprises a date column 831 that stores a payment receipt date (sales data), a device No. column 832 that stores a device No. of stationary terminal 241′, a contents No. column 833 that stores a contents No., a section column 834 that stores data on a sales section of one of a card sales, a valid usable count renewal charge, and a contents renewal charge, and an amount of money column 835 that stores an actual collected payment receipt (sales price).

As shown in FIG. 29D, the questionnaire file data 840 comprises a device No. column 841, a fundamental item column 842, and a contents item column 843. Device No. column 841 stores a device No. of stationary terminal 241′. Fundamental item column 842 stores data on a result of a fundamental questionnaire survey such as a sex, age, occupation, a motive of use of contents, a card acquiring method, a card acquiring place, etc. for the card user. Contents item column 843 stores data on a result of the questionnaire survey about the kind of contents browsed, favorite contents, contents considered good, contents that the user wants to buy, unfavorable contents, a desired price zone, good or bad advertisement, etc.

As shown in FIG. 29E, contents files 285-1 to 285-n each comprise a contents No. column 851 that stores a contents No., a program ID column 852 that stores a browsing program ID used to browse or audition contents, a usage charge column 853 that stores data on a standard (fixed) usage charge, and a contents column 854 that stores contents.

When the contents include a plurality of subcontents files, a pointer column 855 may be provided that stores addresses where the plurality of subcontents files are stored.

4-(5) Composition of Stationary Terminal for Contents Sales

FIG. 30 shows a composition of a stationary terminal for contents sales, which has functions of selling contents cards, browsing contents, renewing a valid usable count (term or deadline) of contents, adding and renewing the contents, and collecting a result of a questionnaire survey. The terminal will be described next.

Terminal 241′ comprises a controller 361, a communication control unit 362, a data transmission unit 363, a key-in unit 364, a display (monitor) 365, an acoustic output 366, a charge collector 367, a contents browser 368, a renewer 369, and a contents card device 370.

Controller 361 comprises a CUP, a RAM, a program storage memory and peripheral circuits. Communication control unit 362 controls communication between terminal 241′ and the Internet 260. Data transmission unit 363 sends commands/data to the server 250 (250′) and receives renewed additional contents from the server 250 (250′). Key-in unit 364 comprises menu selection or questionnaire response keys or a mouse. Display (monitor) 365 displays a menu, message, and/or contents in browsing. Acoustic output 366 outputs music/voice audibly during manipulation of the terminal or contents browsing. Charge collector 367 collects the price for cards sold, a charge for pay contents browse, a charge for browsing pay contents, and charges for renewal of the valid usable count of contents, and addition/renewal of contents, and produces corresponding signals. Contents browser 368 executes contents browsing when the user selects a contents browsing menu. Renewer 369 renews the contents and a valid usable count of the contents. Contents card device 370 comprises a contents card device 230 of FIG. 24.

Charge collector 367 comprises a charge collection slot 245 of FIG. 25B. Contents card device 370 has a card insert/discharge slot 246′. When stationary terminal 241′ also has a function of a contents selling machine, it comprises a plurality of card stockers (not shown) each for stocking a respective one of kinds of contents cards and a conveying mechanism (not shown) that extracts a selected contents card and conveys it to the card insert/discharge slot 246.

Preferably, stationary terminal 241′ for contents sales is installed in a convenience store, a station, a department store or a supermarket or on a street.

4-(6) Operation of Stationary Terminal for Contents Sales

FIG. 32 illustrates a flowchart of operation of the stationary terminal 241′.

Step S201 (Display of a guide picture and user's selection)

It is assumed that terminal 241′ is in operation and connected to the Internet 260. When no contents card is used, it displays on a display unit 365 a guide picture 171 indicating that terminal 241′ is a contents sales terminal.

When the user specifies with keys one of a card purchase icon 172, a usage icon 173, a valid count renewal icon 174, and a contents renewal icon 175, key-in unit 364 sends a corresponding signal to controller 361.

Step S202 (Determination of user's operation)

Controller 361 checks a signal from key-in unit 364. If the signal indicates “card purchase”, the control passes to step S203. If the signal indicates “usage”, the control passes to step S205. If the signal indicates “renewal of a valid usable count”, the control passes to step S207. If the signal indicates “contents renewal”, the control passes to step S217.

Step S203 (Sales of Contents Cards)

The controller 361 displays a contents sales picture of FIG. 31B. When the user selects a desired contents card and puts am amount of money corresponding to the price of the contents into a money insert slot 245′, the controller 361 extracts the selected contents card from the contents cards stocked on the card stocker and delivers it to the card discharge slot 246′. The terminal 241′ may be composed such that when the user selects a contents card, its brief or extract can be displayed or auditioned.

Step S204 (Send Sales Data)

Controller 361 sends the server 250 (250′) data comprising information on a sales of the contents card sold in step S203 via the data transmission unit 363, the communication control unit 362 and the Internet 260, and then returns the control to step S225. The data comprises the information on the sales of the cards further comprises the device No. of the terminal 241′, the contents No. of the sold contents, data on the kind of the sold contents cards (for example, “1”), and the sales volume of the contents (if the contents cards contains different contents except for subcontents, their respective sales volumes).

Data on the sales volume of the contents cards is not sent to the server 250 (250′) each time the contents cards are sold, but may be stored in memory and sent in a lump periodically to the server 250 (250′).

Step S205 (Browse the Contents)

The contents browser 368 extracts the contents browsing program stored in the program area 227 (273, 273′) of the contents card into RAM in a manner similar to that performed in step P3 of FIG. 27, and then starts up the contents browsing program under control of the controller 361. The browser 368 determines whether the contents card is valid. If it is, the browser 368 reads contents information stored in the contents information area 224 (FIGS. 18A′, B′ and C′), and then extracts menu picture contents 251. The browser displays a browsing contents-selecting menu of FIG. 31C. When the user selects a desired menu item, the browser extracts contents corresponding to the selected menu item from the contents data area 225 of the contents card, expands the contents, and displays them on the display 365 (or outputs them audibly from the acoustic output 366). Then, the user browses or auditions the selected contents in steps similar to steps P6-P11.

Step S206 (Calculation and Renewal of the Remaining Valid Usable Counts)

When the user terminates the contents browsing operation, the controller 361 writes a value representing the valid usable count minus 1 (the remaining valid count) over the valid information area 223 and then passes the control to step S222.

In this case, the card ID information and the browsed contents No. may be stored in the memory and sent at a predetermined time via the Internet 260 to the server 250 (250′).

It may be arranged that when the questionnaire survey is to be replied to, the usable count of the card is not be decremented, but incremented, and that the card ID information, the browsed contents No. and the result of the questionnaire survey are stored in the memory, and sent to the server via the Internet 260 at a predetermined time.

Step S207 (Detection of Card Insertion)

When the user selects an icon 174 in step S201, the stationary terminal 241′ displays or audibly outputs a message that urges the user to insert the contents card. When the user inserts the contents card, the terminal 241′ detects the card and sends a signal indicative of the card insertion to the controller 361.

Step S208 (Display and Select a Valid Usable Count Picture)

In this step, a valid usable count select picture 174′ of FIG. 3 1D is displayed. The user selects a desired count from the displayed renewal counts with keys or the mouse.

Step S209 (Determine Whether the Collected Charge is Proper)

When the user puts an amount of money for the contents price displayed on the picture or output audibly in step S208 into the money insert slot 245′ (FIG. 25B), the money collector 367 of the terminal 241′ checks to see whether the put amount of money coincides with the displayed charge. If it does, the control passes to step S210. If the put amount of money exceeds the displayed charge, the changes returns to the money discharge slot 245′ whereas if the put amount of money is less than the displayed charge, the user is required to put a shortage into the money insert slot 245′.

Step S210 (Renew the Valid Count)

The controller 361 adds a valid usable count corresponding to the paid amount of money to the valid information area 223 (275) of the inserted contents card, and stores information on the collected charge in the memory.

Step S211 (Selection of Whether the User Replies to a Questionnaire Survey)

The controller 361 displays on the display 365 “When you reply to a questionnaire survey, your contents are renewed free” and related select icons. When the user selects an icon that indicates user's agree to replying to the questionnaire, the control passes to step S212. If otherwise, the control passes to step S216. Alternatively, the controller 361 may display on the display 365 “If you agree to replying to the questionnaire survey, the contents of your card are renewed at a discount” and related select icons. In this case, when the user selects an icon that indicates the user's agree to replying to the questionnaire survey, the controller 361 returns the user an amount of money representing the difference between the discounted and undiscounted charges. The control then passes to step S212.

Step S212 (Questionnaire Survey)

The controller 361 displays a questionnaire picture (not shown), obtains information through the questionnaire from the user, and stores a result of the questionnaire survey in the memory.

Step S213 (Connection to the Internet and Transmission of a Result of the Questionnaire Survey)

The controller 361 connects to the Internet 260 and sends the server 250 (250′) data on a result of the questionnaire survey and information on the renewed valid usable contents charge. The data on a result of the questionnaire survey further includes the device No. of the terminal 241′, and a data kind code (for example, “2” implying “questionnaire and data”). The information on the renewed contents charge further comprises the device No. of the terminal 241′, contents No., a data kind code (for example “3”) implying a renewed valid usable count charge, and a charge for renewal of the contents card (if the contents card contains different contents except for subcontents, the respective charges for renewal of the different contents).

Arrangement may be such that the controller 361 displays on the display 365 “If you agree to replying to the questionnaire survey, your valid usable count is incremented” and corresponding select icons, that when the user selects an icon indicating your agree to replying to the questionnaire survey, the controller 361 displays a questionnaire picture (not shown), and that when the user replies to the questionnaire, the controller 361 adds a predetermined valid count to the valid information column 223 (275) of the contents card, and then sends a result of the questionnaire survey to the server 250 (250′).

Step P214 (Reception of Renewed Contents)

When the server 250 (250′) receives data on a result of the questionnaire sent in step S213 and the contents of the database corresponding to those of the contents card have been renewed, the server 250 (250′) sends the renewed contents to the terminal 241′ (FIG. 33) and the terminal 241′ receives the renewed contents.

Step S215 (Renewal of the Contents of the Contents Card)

The renewer 369 writes the contents received in step S214 over the contents data area 225 (225′) of the inserted contents card (or renews the contents of the contents card) under control of the controller 361. Step S225 is next.

When in step S212 the controller 361 displays on the display 365 “When you agree to replying to the questionnaire survey, your valid usable count is incremented” and corresponding select icons, no contents are renewed free and the server 250 (250′) sends no renewed contents to the terminal.

Step S216 (Send Information on Collected Charge for Renewed Valid Count)

The controller 361 connects to the Internet 260 and sends the server 250 (250′) data on a charge for the valid usable count renewal. The data on a charge for the valid usable count renewal further includes data on the device No. of the terminal 241′ concerned, the contents No., a data kind code (for example, “3”) indicating a valid usable contents renewal charge data, and the sales price of the contents (if the contents card contains different contents files, the collected charges for renewal of the respective contents files of the card), the card ID information stored in the card ID information area 221 of the contents card, and the collected charge information, and then passes the control to step S225.

Alternatively, the terminal 241′ may store such information accumulatively and connect to the Internet 260 periodically to send the server 250 (250′) in a lump the card ID information and the collected charge information stored in the memory so far without sending such information to the server each time the charge concerned is collected.

Step S217 (Display of Contents Renewal Picture)

When the icon 175 is selected in step S222, the controller 361 displays a menu picture 171 for renewing the contents, as shown by FIG. 31E. In this example, the controller 31 controls the contents card device 370 to display the names of contents \mathring{1}, \mathring{2} , . . . stored in the contents information area 224 (224′) of the contents card. Newly created, addable contents may be displayed in a menu.

Step S218 (Specify Renewal Contents)

When the user specifies and selects one or more contents on a menu picture 171, for example, using keys, the controller 361 stores in the memory the specified contents No(s). (when the menu No. “0” is specified, all the displayed contents Nos. are held). When additional contents are specifyable and selectable, and additional contents are specified, the contents No. is held.

Step S219 (Send Selected Contents No.)

When selection of renewal contents in step S218 ends, the controller 361 sends the server 250 (250′) via the Internet 260 the contents No. stored in the memory in step S218, the device No. of the terminal 241′, a data kind code indicating “contents renewal specifying data” (for example, “4”), and No. or classification No. of specified renewal contents when subcontents are included, and requests of the server 250(250′) that the server sends renewed contents to the terminal 241′.

Step S220 (Reception of Renewal Contents)

When the contents of the database corresponding to the contents of the appropriate card are updated (added), the server 250 (250′) sends the terminal 241′ a list of contents to be sent, renewal charge information and renewed (added) contents in response to the terminal's request. The terminal 241′ receives those data.

Step S221 (Display of Contents List and Charge Information Received)

The controller 361 displays on the display the contents file list and charge information received in step S220 (when there are contained a plurality of contents files, the sum of the charges for those contents files is calculated and indicated along with the respective renewal charges), and urges in a displayed message or audibly the user to put an amount of money corresponding to the total renewal charge of the contents into the money insert slot in the terminal.

Step S222 (Determine Whether the Put Amount of Money is Proper)

When the user puts the amount of money corresponding to the total charge for renewal of the contents into the slot 345′ (FIG. 25B), the money collector 367 of the terminal 241′ checks to see whether the put amount of money coincides with the displayed charge. If it does, the control passes to step S223. If the put amount of money exceeds the charge, a surplus is returned to the slot 245′. If the put amount of money is insufficient, the user is urged to put a shortage into the money insert slot.

Step S223 (Renew Contents)

The renewer 369 writes the contents received in step S220 over the contents data area 225 (225′) of the inserted contents card, i.e., renews the contents of the card, under control of the controller 361.

Step S224 (Send Data on Collected Contents Renewal Charge)

The controller 361 sends the server 250 (250′) data on the collected contents renewal charge and then passes the control to step S225. The data on the collected contents renewal charge further includes the device No. of the terminal 241′, contents No., a data kind code indicating “Collection of contents renewal charge” (for example, “5”), the collected charge for renewal of the contents (if the card contains different contents excluding subcontents, the charges for renewal of the respective contents), the card ID information stored in the card ID information area 221 of the contents card.

Step S225 (Discharge Contents Card)

The terminal 241′ discharges the contents card out of the card discharge slot 246′ and returns the control to step S200.

4-(7) (Operation of the Server)

FIG. 33A is a flowchart of the server's operation involving a contents selling method using the network system of FIG. 26. FIG. 33B illustrates extraction of a browsing program from the server. It is assumed that the server 250 (250′) and the stationary terminal 241′ are connected to the Internet 260.

Step T1 (Detect Received Data)

When the server 250 (250′) receives data from one of a plurality of stationary terminal 241′ connected to the Internet 260 in FIG. 33A, the server stores in a reception buffer data on device No., data kind, and data string.

Step T2 (Determine Data Kind)

The controller 251 checks the kind of data stored in the reception buffer. If it involves “contents card sales data”, the control passes to step T3. If it involves questionnaire data, the control passes to step T6. If it involves data on collection of valid usable count renewal charge, the control passes to step T7. If it involves contents renewal requesting data, the control passes to step T10. If it involves data on collection of contents renewal charge, the control passes to step T14.

Step T3 (Create Detailed Data and Store it in Detailed File)

Under control of the controller 251, the sales data storage 55 stores a date based on a timer in a date column 831, and also stores the device No. extracted from the receive buffer in a device No. column 832. The sales data storage 55 extracts the contents No., data kind code, and card sales from the data string, stores those data in contents No., section and money amount columns 833, 834, 835 sequentially to create detailed data 830, and additionally stores those data in the detailed data file 283 of the database 280 via the data input/output unit 254. If a further different No., excluding subcontents No. is contained, the sales data storage 55 creates detailed data by contents type.

Step T4 (Record Card Sales in a Sales File)

The sales data storage 55 searches the sales files 281 for the respective devices or terminals in the database 280 for the device No. extracted from the receive buffer, and adds card sales in a section having the same date as the cards were sold, in a daily payment receipt list column 812 of the file data having the same device No. as that for which the sale files 281 were searched.

Step T5 (Record Contents Sales in a by-Contents Type Sales File)

The sales data storage 55 searches by-contents type sales amount files 282 of the database 280 for the contents No. extracted from the receive buffer, and adds the card sales price to data in a section, having the same date as the cards were sold, in the monthly sales column 812 of the file data having the same contents No. as that for which the by-contents type sales amount files were searched. The control then returns to step T1.

Step T6 (Create Questionnaire Data and Record the Data in Questionnaire File)

The questionnaire data recorder 256 extracts a device No. from the received data, stores it in a device No. column 841, extracts fundamental questionnaire items from the questionnaire data, and stores them in a fundamental item column 842. The questionnaire data recorder 256 also extracts a result of the questionnaire survey about questionnaire items involving the contents, stores it in a contents item column 843 and in the questionnaire file. The controller then returns the control to step T1.

Step T7 (Create Detailed Data and Record the Data in Detailed File)

Under control of the controller 251, the sales data storage 255 stores a date based on the timer in a date column 832 and also stores the device No. extracted from the receive buffer in a device No. column 832. The sales data storage 255 extracts from the data string the contents No., data kind code, and renewed usable valid count charge, stores them in corresponding columns 833, 834, and 835 sequentially to create detailed data 830, and additionally stores the detailed data in a detailed data file 283 of the database 280 via the data input/output unit 254. When the contents numbers are different excluding subcontents Nos., detailed data are created for the respective contents.

Step T8 (Record Card Sales in a Sales File for a device)

The sales data storage 55 searches the sales files 281 for the respective device in the database 280 for the device No. extracted from the receive buffer, and adds a charge for the renewed valid usable count to data in a section, having the same date as the cards were sold, in the daily payment receipt column 812 of the file data having the same device No. as that for which the sales files 281 were searched.

Step T9 (Record Contents Sales in a by-Contents Type Sales File)

The sales data storage 255 searches by-contents type sales amount files 282 of the database 280 for the contents No. extracted from the receive buffer, and adds a charge for the renewed valid usable count to data in a section, having the same date as the cards were sold, in a monthly sales column 822 of the file data having the same contents No. as that for which the by-contents type sales amount files 282 were searched. The control then returns to step T1.

Step T10 (Retrieval of Contents Files to be Renewed)

The controller 251 sequentially extracts the contents Nos. and renewal dates of contents files whose renewal was specified from the data received in step T1. That is, the controller 251 searches contents files 285-1 to 285-n of the database 280 for each of the target contents Nos., and extracts the renewal date of the contents file having the same contents No. as that for which the contents files 285-1 to 285-n were searched.

Step T11 (Determine whether Target Contents are Renewable)

The controller 251 compares the renewal date of contents extracted in step T10 with a respective one of the renewal dates of the contents files whose renewal is specified. If the renewal date of each of the contents files whose renewal is specified is older than the renewal date of the corresponding contents file extracted from the database, the controller 251 determines that the target contents files are already renewed and passes the control to step T12. If otherwise, the control passes to step T13.

Step T12 (Send Updated Contents)

The controller 251 sends the appropriate stationary terminal 241′ the contents (compressed) file having the same contents No. mentioned in step T10 and the renewal charge information via the data transmission unit 253 and the Internet 260.

Step T13 (Determine the End of Processing of Contents to be Renewed)

The controller 251 repeats steps T11-T12 about the contents Nos. of all the contents files stored in the receive data storage and to be renewed. Then the controller 251 returns the control to step T1.

Step T14 (Create Detailed Data and Record the Data in Detailed Data File)

Under control of the controller 251, the sales data storage 255 stores a date based on the timer in a date column 832 and also stores the device No. extracted from the receive buffer in a device No. column 832. The sales data storage 255 extracts from the data string the contents No., data kind code, and (collected) contents renewal charge, stores them in corresponding columns 833, 834, and 835 sequentially to create detailed data 830, and additionally stores the detailed data in a detailed data file 283 of the database 280 via the data input/output unit 254. When the contents numbers are different excluding subcontents Nos., detailed data are created for the respective contents files.

Step T15 (Record Contents Renewal Charge in a Device's Charge Sales File)

The sales data storage 55 searches the sales files 281 for the respective devices in the database 280 for the device No. extracted from the receive buffer, and adds contents renewal charge to data in a section having the same date as the cards were sold in the daily payment receipt column 822 of the file data having the same device No. as that for which the sales files 281 were searched.

Step T16 (Record Contents Sales in a by-Contents Sales File)

The sales data storage 255 searches the by-contents type sales amount files 282 of the database 280 for the contents No. extracted from the receive buffer, and adds the contents renewal charge to data in a section, having the same month as the contents were renewed, in the monthly sales amount column 812 of the file data having the same contents No. as that for which the by-contents type sales amount files 282 were searched. The control then returns to step T1.

Step T17 (Extract a Contents No.)

The controller 251 extracts the contents No. (or contents classification No.) from the data received in step T1.

Step T18 (Retrieval of a File corresponding to the Contents)

The controller 251 searches contents files 285-1 to 285-n of the database 280 for a contents No. (or contents classification No.). The controller 251 then extracts a contents browsing program ID from a program ID column 2852 of the contents file having the contents No. The controller 251 then searches browsing programs (program files) stored in the browsing program storage area 86 for the browsing program ID, and then obtains the browsing program having the program ID.

Step T19 (Send the Browsing Program)

The controller 251 then sends the browsing program (compressed file) obtained in step T18 to the appropriate stationary terminal 41′ via the data transmission unit 253 and the Internet 260.

Step T20 (Determine the End of the Contents to be Renewed)

The controller 251 repeats steps T17-T19 about all the contents Nos. of the contents files stored in the received data and to be renewed. When this process ends, the controller 251 returns the control to step T1.

4-(8) Acquisition (Reception) of a Program by Terminal in Contents Browsing

FIGS. 34A and B each illustrate a flowchart of the detailed operation of step P3 of FIG. 27A involving acquisition (reception) of a program by a contents browsing terminal.

In FIG. 34A, it is assumed that the terminal has installed Internet connection programs such as a card driver and a WWW browser so that the terminal is connected to the Internet with browsing programs being stored in the contents card. In FIG. 34B, the terminal has installed an Internet connection programs such as a WWW browser so that the terminal is connected to the Internet with the browsing programs being stored in the server (See 3-(3)-2).

4-(8)-(A) Extraction of a Program from a Contents Card

Step U1 (Start up the Card Driver)

In FIG. 34A when the contents card is inserted into the terminal, its controller starts up the card driver (installed already in this terminal).

Step U2 (Determine the Kind of the Contents Card)

When the contents card is accessible, the controller reads data in a card ID information area 221 (71) of the contents card and examines the kind of the contents card (FIGS. 18A, B, C; A′, B′, C and FIGS. 23A, A′, B, B′).

Step U3 (Start up a Browsing Program Loader)

The controller (not shown) of the terminal starts up a contents browsing program loader (program) corresponding to the kind of the contents card (i.e., the contents) determined in step U1 among the contents browsing program loaders contained in the card driver.

Step U4 (Extraction of a Program from the Contents Card)

The controller of the terminal controls the contents browsing program loader, reads the browsing program from the program area 225 (273) of the contents card, and stores the program in RAM via a buffer of the terminal. Thus, the contents browsing program is placed in an executable state.

4-(8)-(B) Download a Program from the Server

Step U1′ (Start up a Card Driver)

In FIG. 34B when the contents card is inserted into the terminal, the controller of the terminal starts up the card driver (already installed in the terminal).

Step U2′ (Read Card ID Information)

When the contents card is accessible, the controller reads contents information from the contents information area 224 (24′) of the contents card, and stores it in RAM.

Step U3′ (Send the Server a Program Reception Request)

The controller of the terminal sends the server 250 (250′) via the Internet 260 a request to receive a contents browsing program from the server, the contents No. of the contents information stored in RAM in step U2′ and the device No. of the terminal 241′.

Step U4′ (Receive the Program from the Server)

When the controller of the terminal 241′ receives the contents browsing program for the contents card from the server 250 (250′), it stores the program in the receive buffer of the terminal and then in RAM (FIG. 33B). Thus, the browsing program is placed in an executable state.

When a WWW browser is used as the browsing program in the Internet in the flowchart of FIGS. 32; 33A, 33B; and 34A, 34B, the programs each may be composed of a HTML file and the contents files 285-1 to 285-n may each be a data file related to a HTML file. In this case, the WWW browser is stored in the terminal whereas data files that are each referred to on a web page produced based on a HTML file are stored in the contents data area 225 (25′) of the contents card. In the example of FIG. 33B, a HTML file is downloaded instead of the corresponding browsing program.

While in the contents sales described above the valid usable count and contents are illustrated as being renewed only in the stationary terminal 241′, the present invention is not limited to this particular case. For example, before the valid usable count and/or contents are renewed, the user may be registered in the server so that the respective terminals 241, 241′ and 241″ can renew the valid usable count and contents of the card, and renew the usable count and/or contents.

The stationary terminal may be a stand-alone type not connected to the network. In this case, the stationary terminal may removably receive a recording medium that has stored collected charges and a recording medium that has stored contents to be renewed.

The shape of the contents card used in each of the embodiments is not limited to a square one. The network used is not limited to the Internet (or a wireless network).

While the several embodiments of the present invention have been illustrated, the present invention is not limited to those particular ones. Various changes and modification are possible, of course, without departing from the spirit and scope of the invention defined in the claims attached hereto.

According to the invention, the recording medium is only required to store retrieval data to thereby simplify the storage control. Since the contents data can be retrieved based on the retrieval data, the contents data is placed in a manageable state.

According to the invention, the recording medium is only required to store index data to thereby simplify the storage control. Since detailed data can be retrieved based on the index data, the detailed data is placed in a manageable state.

According to the invention, the recording medium is only required to store compressed data corresponding to high quality data to thereby simplify the storage control. Since high quality data corresponding to the compressed data can be retrieved, the high quality data is placed in a manageable state.

According to the invention, the recording medium is only required to store security information to thereby avoid complication of the storage control. The security of the storage medium and contents data is ensured.

According to the invention, a system is constructed in which recording mediums having stored pay and free contents data are distributed with the pay contents data being readable on condition that their charges are paid. Especially, according to the invention, the information stored in the server system can be downloaded and stored in the recording medium.

What is claimed is:

1. A data managing apparatus for accessing a recording medium that comprises a first storage area in which information is stored in a first access method and a second storage area in which fixed data is stored in a second access method different from the first access method, the apparatus comprising:
connecting means-for connecting the recording medium via a network to a server system on the Internet;
storage control means for storing changing data, related to the fixed data and read from said server system, in said first storage area in the first access method; and
reading means for reading the fixed data corresponding to the changing data in the second access method from said second storage area.

2. A data managing apparatus for accesing a recording medium that comprises a first storage area in which information is stored in a first access method and a second storage area in which contents data is already stored in a second access method different from the first access method, the apparatus comprising:
storage control means for storing retrieval data related to the contents data in said first storage area in the first access method; and
reading means the contents data corresponding to the retrieval data from said second storage area in the second access method.

3. A data managing apparatus for accessing a recording medium that comprises a first storage area in which information is stored in a first access method and a second storage area in which detailed data is stored in a second access method different from the first access method, the apparatus comprising:
storage control means for storing in said first storage area index data, related to the detailed data, in the first access method; and
reading means for reading the detailed data corresponding to the index data from said second storage area in the second access method.

4. A data managing apparatus for accessing a recording medium that comprises a first storage area in which information is stored in a first access method and a second storage area in which uncompressed high-definition data is stored in a second access method different from the first access method, the apparatus comprising:
storage control means for storing in said first storage area compressed data, related to the high quality data, in the first access method; and
reading means for reading the high quality data, corresponding to the compressed data, in the second access method from said second storage area.

5. A data managing apparatus for accessing a recording medium that comprises a first storage area in which information is stored in a first access method and a second storage area in which high-definition data is stored in a second access method different from the first access method, the apparatus comprising:
storage control means for storing in said first storage area in the first access method thumbnail data related to the high-definition image data and having a reduced amount of information; and
reading means for reading the high-definition image data corresponding to the thumbnail data from said second storage area in the second access method.

6. The data managing apparatus according to claim 1, wherein said storage control means further stores security information in the recording medium in said first storage area.

7. The data managing apparatus according to claim 6, wherein the security information in the recording medium comprises a personal authentification code and information for inhibiting copying data stored in the recording medium.

8. The data managing apparatus according to claim 1, wherein said storage control means stores security information for the contents data in said first storage area.

9. The data managing apparatus according to claim 8, wherein the security information for the contents data comprises information for inhibiting copying the contents stored in the recording medium.

10. The data managing apparatus according to claim 1, wherein said first storage area comprises a static storage area and said second storage area comprises a dynamic storage area.

11. A data managing method of accessing a recording medium that comprises a first storage area in which information is stored in a first access method and a second storage area in which fixed data is stored in a second access method different from the first access method, the method comprising:
connecting the recording medium to a server system on the Internet via a network;
storing changing data, related to the fixed data and read from the server system, in said first storage area in the first access method; and
reading the fixed data corresponding to the changing data in the second access method from said second storage area.

12. A data managing method of accesing a recording medium that comprises a first storage area in which information is stored in a first access method and a second storage area in which contents data is stored in a second access method different from the first access method, the method comprising:
storing retrieval data related to the contents data in said first storage area in the first access method; and
reading the contents data corresponding to the retrieval data from said second storage area in the second access method.

13. A data managing method of accessing a recording medium that comprises a first storage area in which information is stored in a first access method and a second storage area in which detailed data is stored in a second access method different from the first access method, the data managing comprising:
storing in said first storage area index data, related to the detailed data, in the first access method; and
reading the detailed data corresponding to the index data from said second storage area in the second access method.

14. A data managing method of accessing a recording medium that comprises a first storage area in which information is stored in a first access method and a second storage area in which uncompressed high-definition data is stored in a second access method different from the first access method, the data managing comprising:
storing in said first storage area compressed data, related to the high-definition data, in the first access method; and
reading the high-definition data corresponding to the compressed data from said second storage area in the second access method.

15. A data managing method of accessing a recording medium that comprises a first storage area in which information is stored in a first access method and a second storage area in which high-definition image data is stored in a second access method different from the first access method, the data managing comprising:
storing in said first storage area thumbnail data related to the high-definition image data and having a reduced amount of information in the first access method; and
reading the high-definition image data corresponding to the thumbnail data from said second storage area in the second access method.

16. The data managing method according to claim 11, wherein said first storage area comprises a static storage area and said second storage area comprises a dynamic storage area.

17. A data reading apparatus for reading data from an optical recording medium of a card shape having free and pay contents data stored in a first and a second storage area thereof, respectively, said apparatus comprising:
reading means for reading the free and pay contents data;
inhibiting means for inhibiting said reading means from reading the pay contents data; and
permitting means for permitting said reading means to read the pay contents data in accordance with predetermined procedures.

18. The data reading apparatus according to claim 17, comprising connecting means for connecting the recording medium to a server system of a center via the Internet.

19. An information managing system comprising an optical recording medium of a card shape having free and pay contents data stored in a first and a second storage area thereof, respectively, and a reader for reading the contents data from the recording medium, wherein one of the recording medium and the reader comprises:
means for permitting said reader to read the free contents data from the medium and for inhibiting said reader from reading the pay contents data from the medium; and
permitting means for permitting said reader to read the pay contents data in accordance with predetermined procedures.

20. The information managing system according to claim 19, wherein said inhibiting means is provided in said storage medium.

21. The information managing system according to claim 19, wherein said inhibiting means is provided in said reader.

22. The information managing system according to claim 19, wherein the recording medium comprises switching means for switching the free contents data to the pay contents data in accordance with the predetermined procedures.

23. The information managing system according to claim 19, wherein said reader comprises connecting means for connecting the recording medium to a server system via the Internet.

24. The information managing system according to claim 19, wherein the recording medium further comprises an electronic storage area.

25. The information managing system according to claim 24, wherein said electronic storage area comprises said permitting means.

26. An information managing system comprising an optical recording medium of a card shape having free and pay contents data stored in a first and a second storage area thereof, respectively, a reader for reading the contents data from the recording medium, and a server system on the Internet to which the reader is connectable, the server system being controlled by a center on the Internet, wherein one of the recording medium and the reader comprises:
means for permitting said reader to read the free contents data and for inhibiting said reader from reading the pay contents data; and
permitting means for permitting said reader to read the pay contents data in accordance with predetermined procedures.

27. The information managing system according to claim 26, wherein said inhibiting means is provided in said server system.

28. The information managing system according to claim 26, wherein said procedures comprise payment of a required charge to the center.

29. The information managing system according to claim 26, wherein said procedures comprise inputting authentication data from said reader to said server system.

30. A method of reading data from an optical recording medium of a card shape having stored free and pay contents data in a first and a second storage area thereof, respectively, the method comprising the steps of:
inhibiting reading means, capable of reading the free and pay contents data, from reading the pay contents data; and
permitting the reading means to read the pay contents data in accordance with predetermined procedures.
